(19) United States
(12) Patent Application Publication
(10) Pub. No.: US 2019/0255730 A1
(43) Pub. Date: Aug. 22, 2019

(54) SUBMICRON PARTICLE COMPOSITIONS

(71) Applicant: PRESTECH LIMITED, Auckland (NZ)

(72) Inventor: Nigel Paul MAYNARD, Auckland (NZ)

(73) Assignee: PRESTECH LIMITED, Auckland (NZ)

(21) Appl. No.: 16/308,336

(22) PCT Filed: May 29, 2017
(86) PCT No.: PCT/IB2017/053141

§ 371 Date: Dec. 7, 2018

(30) Foreign Application Priority Data
Jun. 10, 2016 (NZ) 721031

(51) Int. Cl. B27K 3/00; B27K 3/36; B27K 3/22

(52) U.S. Cl. CPC B27K 3/005; A01N 25/04; B27K 3/22; B27K 3/36

(57) ABSTRACT

Disclosed is a method of preparing compositions comprising submicron particles of a metal salt. The method comprises providing an aqueous alkaline solution comprising a metal, one or more ligand that forms a soluble complex with the metal under alkaline conditions, and optionally one or more dispersant; and admixing the solution and a source of carbon dioxide to reduce the pH of the solution such that submicron particles of a metal salt precipitate. Also disclosed are compositions prepared by the method. Also disclosed is a method of treating a substrate, such as lumber, comprising applying the compositions and substrates treated by the method.

### FIELD OF THE INVENTION

The present invention relates to a method of preparing compositions comprising submicron particles of a metal salt and to compositions prepared by the method. The present invention also relates to a method of treating a substrate comprising applying the compositions and to substrates treated by the method.

### BACKGROUND

Methods for preparing compositions comprising submicron particles can comprise milling of compounds or mixtures thereof in the presence or absence of water or solvents. In the wood preservation industry in recent years metal compounds are wet milled to sub-micron size; typically these compounds comprise copper carbonate or copper hydroxide.

The compositions thus formed can be used to treat substrates such as lumber. Treatment methods may vary depending on the nature of the substrate to which the composition is to be applied, and whether or not the composition is required to penetrate the surface of the substrate. Many of the known methods include as examples true solutions of biocides, suspensions or micro-suspensions of biocides, encapsulated biocides and emulsions or micro-emulsions of biocides.

Lignocellulosic materials for example are generally treated with biocides subsequent to felling and milling trees in an attempt to extend their service life. Living plants are generally treated whilst growing to encourage health and to promote good yield of crop therefrom. Leather (the hide of an animal) is treated subsequent to processing of the carcass for meat. All such substrates being organic are subject to attack by degrading organisms such as bacteria, fungi and insects. There are other substrates which can be subject to attack by such organisms, such as the surface of painted objects and concrete. Such attack reduces the service life of these substrates, degrades the appearance, and results in cost of replacement or potential hazard due to failure. In the likes of plants degrade can reduce crop yield.

To mitigate infection or infestation by these pests methods have been developed to treat these substrates with a variety of chemicals by various physical processes using products of differing properties.

Lignocellulosic substrates comprise complex structures including wood cells interconnected by pits which include a membrane otherwise acting as a valve system when the tree is living. When trying to treat the interior of this substrate such cells and cell interconnections offer impedance to the flow of preservative into the substrate. This is more particularly so when the substrate is dry because the pit membranes aspirate, that is they collapse to either side of the pit and effectively seal it shut. Drying of the substrate however is important prior to treatment with preservative because space is required within which to place the preservative.

Certain modern preservatives for lumber include the likes of Ammoniacal Copper Quaternary and Copper Azoles. These both require addition of ammonia or amines to solubilise the copper component and these must remain in the composition during use. Ammonia is a toxic gas which in addition to cost is a hazard to workers. Amines have been used to replace ammonia but these exacerbate cost.

An important component of Ammoniacal Copper Quaternary compositions is copper carbonate, also known as basic copper carbonate. Traditional methods of production include reaction of acidic solutions of copper sulphate with sodium carbonate. All Ammoniacal Copper Carbonate compositions are true solutions, which facilitates impregnation into the substrate, but are corrosive due to the presence of dissolved cationic copper species and readily leach from the treated substrate.

Corrosivity is a problem with many traditional soluble biocides such as Copper Chrome Arsenate and Ammoniacal Copper Quaternary. Industry has sought alternatives that do not suffer this disadvantage.

Preservative or biocidal compositions can also be used for living substrates including for the treatment of plants. Care must be taken not to include phytotoxic components. For example an insecticide or fungicide for application to a living plant must not contain excessive levels of organic solvents such as xylene because this could cause plant death. Further a fungicide must be around neutral pH otherwise damage to the plant can occur. The majority of copper containing plant protectants are based on insoluble compounds, the principle reasons being that soluble copper compounds are phytotoxic and readily wash off into the environment. Examples of traditional insoluble copper based fungicides for plants include Bordeaux mixture which comprises copper hydroxide, and Burgundy mixture, which comprises basic copper carbonate.

Such compounds can also be used for treatment of non-living substrates such as leather, concrete and the like.

Similarly metal compounds can be used as pigments and as catalysts in many areas of industry.

Performance can be enhanced significantly when metal compounds are comprised of small particle sizes. This includes biocides, pigments and catalysts. There has been a trend in modern times towards the use of smaller and smaller particle sizes, including nano-particles. Due to the higher bio-availability, and/or the higher pigmentation, and/or the higher catalytic value it is preferable that these metal compounds have very small particle size and large surface area to enhance their biological, visual or catalytic properties.

Current biocidal compositions include components which can be flammable, toxic, and environmentally hazardous. Any component other than the selected biocide contributes cost to the composition.

Colloidal water preservatives have been known for nearly 100 years. For example, GB 387819 teaches preservation of wood using colloidal arsenic trisulphide preservatives.

To treat the likes of wood the particle size should be less than 1 micron otherwise the pathways into the substrate which are small may block causing poor penetration and distribution of the preservative.

An issue which may affect the performance of sub-micron biocides prepared by wet milling when used in wood preservation, is that the wood substrate has a natural pH between 4 and 5. Sub-micron biocides prepared by the wet milling process typically have a pH between 7 and 10, and thus might become destabilised when used to treat the more acidic wood because of the buffering effect of the substrate, particularly when repeat cycles of vacuum/pressure techniques are used in the treatment process. The preservative composition is frequently used over a number of cycles and thus the particle dynamics in the composition might change and this might affect the particle size. Should the particle size increase there exists the possibility penetration will be poor due to blockage of the pathways.

Similarly, markets exist for compositions containing sub-micron pigments particularly inorganic pigments such as copper carbonate which is green, zinc carbonate which is white, nickel carbonate which is pale green, copper oxide which is black, copper borate which is green. All such compounds can be used in ceramics and as catalysts. Such pigments can be included in wood preservatives to enhance the colour of the treated wood. These also are expensive to produce.

Transition metal oxides are used as catalysts. Examples include the use of nano-particulate copper oxide and nickel oxide in the catalytic oxidation of methanol. Catalysts for conversion of carbon monoxide and hydrogen include zinc oxide and copper oxide.

There is an ongoing need for methods of preparing compositions comprising submicron particles of metal salts.

It is an object of the present invention to go some way to meeting this need, and/or to at least provide the public with a useful choice.

Other objects of the invention may become apparent from the following description which is given by way of example only.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date.

### SUMMARY OF THE INVENTION

In one aspect, the present invention provides a method of preparing a composition comprising submicron particles of a metal salt, the method comprising:
providing an aqueous alkaline solution comprising a metal, one or more ligand that forms a soluble complex with the metal under alkaline conditions, and optionally one or more dispersant;
admixing the solution and a source of carbon dioxide to reduce the pH of the solution such that submicron particles of a metal salt precipitate, thereby providing an aqueous composition comprising submicron particles of the metal salt.

In another aspect, the present invention provides a method of preparing a composition comprising submicron particles of a metal salt, the method comprising:
providing an aqueous alkaline solution comprising a metal, one or more ligand that forms a soluble complex with the metal under alkaline conditions, and one or more dispersant;
admixing the solution and a source of carbon dioxide to reduce the pH of the solution such that submicron particles of a metal salt precipitate, thereby providing an aqueous composition comprising submicron particles of the metal salt.

The following embodiments and preferences may relate alone or in any combination of any two or more thereof to the above aspects and other aspects herein.

In various embodiments, the aqueous composition comprising submicron particles is a colloidal dispersion; or the aqueous composition comprising submicron particles is a flocculated composition and the method further comprises deflocculating the composition to provide a colloidal dispersion.

In various embodiments, the aqueous composition comprising submicron particles is a colloidal dispersion.

In various embodiments, the aqueous composition comprising submicron particles is a flocculated composition; and the method further comprises deflocculating the flocculated composition to provide a colloidal dispersion.

In various embodiments, deflocculating the flocculated composition comprises diluting the composition.

In other embodiments, deflocculating the flocculated composition comprises sonicating the composition.

In various embodiments, admixing the solution and the source of carbon dioxide reduces the pH of the solution such that submicron particles of a metal carbonate precipitate.

In various embodiments, admixing the solution and the source of carbon dioxide reduces the pH of the solution such that submicron particles of a metal borate precipitate. In some embodiments, submicron particles of a metal carbonate and submicron particles of a metal borate precipitate and/or submicron particles of both a metal carbonate and a metal borate precipitate.

In various embodiments, the soluble metal complex is decomposed on reducing the pH of the alkaline solution.

In various embodiments, the soluble metal complex reacts with carbon dioxide provided by the source of carbon dioxide.

In various embodiments, one or more ligand of the soluble metal complex is released from the soluble metal complex and/or a salt of one or more ligand of the soluble metal complex is produced by decomposition of the soluble metal complex.

In various embodiments, the one or more ligand released or salt thereof produced reduces or prevents aggregation and/or settling of the submicron particles.

In certain embodiments, the one or more ligand released or salt thereof produced is selected from ammonium carbonate, a carbonate of an amine, and a glycol.

In various embodiments, the solution further comprises a source of one or more acid. In various embodiments, the solution further comprises a source of one or more weak acid.

In various embodiments, the method comprises admixing the solution, a source of carbon dioxide, and one or more weak acid (prior to, during, and/or after admixing the solution and the source of carbon dioxide) to reduce the pH of the solution such that submicron particles of a metal salt precipitate.

In various embodiments, the weak acid is a weak acid has a pKa of at least about 6, 6.5, 7, 7.5, 8, 8.5, 9, 9.5, or 10. In various embodiments, the pKa is from about 6 to 15, 6 to 14, 6 to 13, 6 to 12, 6 to 11, 6 to 10, 6 to 9.5, or 6 to 9.

In various embodiments, the weak acid is a weak acid that forms a substantially insoluble salt with the metal in water at pH 7. In various embodiments, the weak acid is a weak acid that also forms a substantially insoluble salt with the metal in water at a pH from about 8 to 9.

In various embodiments, the weak acid is boric acid or a phenol.

In various embodiments, the weak acid is boric acid.

In various embodiments, the weak acid is boric acid and the metal salt precipitated comprises a metal borate.

In various embodiments, the method comprises admixing a source of boric acid, such as boric acid or a borate, and a composition comprising submicron particles of a metal carbonate to provide a composition comprising submicron particles of a metal borate.

In various embodiments, the source of the weak acid is boric acid or a borate.

In various embodiments, the source of the weak acid is borax.

In various embodiments, the metal salt precipitated comprises a salt of the weak acid.

In various embodiments, the aqueous composition comprises submicron particles of a carbonate of the metal and the method further comprises treating the aqueous composition comprising submicron particles of a carbonate of the metal with a base (for example, an alkali metal hydroxide) to provide an aqueous composition comprising submicron particles of a hydroxide of the metal. In various embodiments, the base is an alkali or alkaline earth metal hydroxide.

In various embodiments, the aqueous composition comprises submicron particles of a carbonate of the metal or a hydroxide of the metal and the method further comprises heating the aqueous composition comprising submicron particles of a carbonate of the metal or the aqueous composition comprising submicron particles of a hydroxide of the metal to provide an aqueous composition comprising submicron particles of an oxide of the metal.

In various embodiments, the source of carbon dioxide is carbon dioxide gas, a solution comprising carbon dioxide, a latent source of carbon dioxide, or a combination of any two or more thereof.

In various embodiments, the source of carbon dioxide is carbon dioxide gas or a solution comprising carbon dioxide and the metal salt precipitated is a metal carbonate.

In various embodiments, the source of carbon dioxide is carbon dioxide gas or a solution comprising carbon dioxide.

In certain embodiments, the source of carbon dioxide is carbon dioxide gas.

In various embodiments, the source of carbon dioxide is carbon dioxide gas and the carbon dioxide gas is admixed with the aqueous alkaline solution under pressure (i.e. a pressure greater than atmospheric pressure), for example in a high pressure reactor.

In certain embodiments, the source of carbon dioxide is a solution comprising carbon dioxide.

In various embodiments, the solution comprising carbon dioxide is saturated with carbon dioxide.

In other embodiments, the source of carbon dioxide is a latent carbon dioxide source.

In various embodiments, the latent carbon dioxide source is an organic carbonate (for example, ethylene carbonate or dimethyl carbonate).

In various embodiments, the source of carbon dioxide is an organic carbonate and method comprises heating the solution and admixed organic carbonate to increase the rate of decomposition of the organic carbonate to carbon dioxide.

In various embodiments, the method further comprises admixing the solution and a source of carbon dioxide with agitation. Preferably the agitation is high shear.

In various embodiments, the metal salt has a solubility in water of less than 0.1 g/L at 20° C., for example less than 0.01, 0.009, 0.008, 0.007, 0.006, 0.005, 0.004, 0.003, or 0.002 g/L at 20° C. For example, copper carbonate has solubility in water of 1.46×10⁻⁵ g/L at 20° C., whereas cupric hydroxide has solubility of 1.722×10⁻⁷ g/L at 20° C.

In various embodiments, the pH of the solution is reduced to a pH from about 4.5 to about 10, for example about 4.5 to 9.5, 5 to 10, 5 to 9.5, 5 to 9, 5.5 to 10, 5.5 to 9.5, 5.5 to 9.

In various embodiments, the pH of the solution is reduced to a pH from about 4.5 to about 9.

In various embodiments, the pH of the solution is reduced to a pH from about 6 to about 10, for example from about 6 to 9.5, 6 to 9, 6.5 to 10, 6.5. to 9.5, 6.5 to 9, 7 to 10, 7 to 9.5, 7 to 9, 7.5 to 10, 7.5 to 9.5, 7.5 to 9, 8 to 10, 8 to 9.5, or 8 to 9.

In certain embodiments, the pH of the solution is reduced to a pH from about 7.5 to about 9.5.

In various embodiments, the pH of the solution is reduced to a pH from about 8 to about 9.

In various embodiments, providing the aqueous alkaline solution comprises:
providing an aqueous alkaline precursor solution comprising a metal, and one or more ligand that forms a soluble complex with the metal under alkaline conditions; and
optionally admixing one or more dispersant.

In various embodiments, providing the aqueous alkaline solution comprises:
providing an aqueous alkaline precursor solution comprising a metal, and one or more ligand that forms a soluble complex with the metal under alkaline conditions; and
admixing the one or more dispersant.

In various embodiments, providing the alkaline solution or alkaline precursor solution comprises reacting a source of the metal and one or more ligand that forms a soluble complex with the metal under alkaline conditions in an aqueous alkaline medium comprising a base (for example, sodium hydroxide, potassium hydroxide, ammonia, or an amine).

In various embodiments, the base is an alkali metal hydroxide such as sodium hydroxide or potassium hydroxide, ammonia, or an amine.

In various embodiments, the source of the metal is a metal compound or elemental metal.

In various embodiments, the source of the metal is a metal salt or elemental metal. In exemplary embodiments, the source of the metal is a metal salt.

In various embodiments, the pH of the alkaline solution and/or alkaline precursor solution is at least 9, 9.5, 10, 10.5, 11, 11.5, 12, 12.5, 13, 13.5, or 14, and useful ranges may be selected from any two of these values, for example from 9 to 14, 9 to 13.5, 9 to 13, 9 to 12.5, 9 to 12, 9 to 11.5, 9 to 11, 9 to 10.5, 9 to 10, 9.5 to 14, 9.5 to 13.5, 9.5 to 13, 9.5 to 12.5, 9.5 to 12, 9.5 to 11.5, 9.5 to 11, 9.5 to 10.5, 9.5 to 10, 10 to 14, 10 to 13.5, 10 to 13, 10 to 12.5, 10 to 12, 10 to 11.5, 10 to 11, or 10 to 10.5.

In various embodiments, the one or more ligand is selected from the group consisting of ammonia, amines, and glycols, such as diols, triols, and polyhydric alcohols.

In exemplary embodiments, the one or more ligand is selected from the group consisting of glycerol, ethylene glycol, and ammonia.

In various embodiments, the soluble complex is a metal-glycol, metal-ammine, or metal-amine complex.

In various embodiments, the ligand forms a complex with the metal that is soluble under alkaline conditions and unstable at neutral pH. In various embodiments, the soluble metal complex is decomposed on reducing the pH of the alkaline solution.

In various embodiments, the metal is a first, second, or third transition series metal.

In various embodiments, the metal is nickel, copper or zinc. In exemplary embodiments, the metal is copper or zinc.

In exemplary embodiments, the metal is copper (II) or zinc (II). In certain embodiments, the metal is copper (II).

In various embodiments, the aqueous alkaline solution and/or aqueous alkaline precursor solution and/or aqueous composition comprises one or more organic solvent.

In various embodiments, the one or more organic solvent is water miscible. In other embodiments, the one or more organic solvent is water immiscible.

In various embodiments, the one or more of the solvents can be in a super critical state.

In various embodiments, one or more of the solvents can be a super critical solvent in admixture with a co-solvent.

In various embodiments, the aqueous alkaline solution and/or aqueous alkaline precursor solution and/or aqueous composition comprising submicron particles further comprises one or more surfactant.

In various embodiments, the method further comprises admixing one or more surfactant with the aqueous alkaline solution and/or aqueous alkaline precursor solution and/or the aqueous composition comprising submicron particles.

In various embodiments, the method further comprises admixing one or more additional dispersant with the aqueous alkaline solution and/or the aqueous composition comprising submicron particles. The one or more additional dispersant can be the same or different as one or more dispersant already present in the alkaline solution.

In various embodiments, the dispersant is an anionic dispersant such as a polycarboxylate for example polyacrylate, a naphthalene sulphonate formaldehyde condensate, a lignosulphonate, a melamine sulphonate formaldehyde condensate, an alkyl-aryl ether phosphate, or an alkyl ether phosphate, a cationic dispersant, a non-ionic dispersant such as a polyether including mixed polyethers or polyvinylpyrrolidone, a zwitterionic dispersant such as a zwitterionic polymer, or a combination of any two or more thereof.

In certain exemplary embodiments, the dispersant is a polyacrylate, a polyether, a naphthalene sulphonate formaldehyde condensate, or a combination of any two or more thereof.

In certain exemplary embodiments, the dispersant is a polyacrylate or a polyether, or a combination thereof.

In various embodiments, the surfactant is an anionic surfactant such as dodecylbenzenesulphonate, lauryl sulphate, or dodecylsulphate, a cationic surfactant such as benzalkonium chloride or hexadecyltrimethylammonium bromide, a non-ionic surfactant such as nonylphenolethoxylate or octylphenol ethoxylate, a zwitterionic surfactant, or a combination of any two or more thereof.

In various embodiments, the surfactant is sodium dodecylbenzenesulphonate, sodium dodecylsulphate, sodium lauryl sulphate, benzalkonium chloride, hexadecyltrimethylammonium bromide, nonylphenolethoxylate, octylphenol ethoxylate, or a combination of any two or more thereof.

In various embodiments, the method further comprises adjusting the pH of the alkaline solution and/or the alkaline precursor solution and/or the aqueous composition comprising submicron particles by admixing acid or base. In various embodiments, the method further comprises adjusting the pH of the aqueous alkaline solution and/or the aqueous alkaline precursor solution and/or the aqueous composition comprising submicron particles by the addition of acid or base.

In various embodiments, the pH is adjusted by admixing a weak acid or base.

In various embodiments, the pH is adjusted by the addition of a weak acid or base.

In various embodiments, the pH is adjusted by admixing boric acid and/or a borate, such as borax. In various embodiments, the pH is buffered by admixing boric acid and/or a borate, such as borax.

In certain embodiments, the pH of the aqueous composition comprising submicron particles is adjusted to a pH from about 6 to 10, for example from about 6 to 9.5, 6 to 9, 6.5 to 10, 6.5. to 9.5, 6.5 to 9, 7 to 10, 7 to 9.5, 7 to 9, 7.5 to 10, 7.5 to 9.5, 7.5 to 9, 8 to 10, 8 to 9.5, or 8 to 9. In certain embodiments, the pH of the aqueous composition comprising submicron particles is adjusted to a pH from about 7.5 to 9.5. In certain exemplary embodiments, the pH of the aqueous composition comprising submicron particles is adjusted to a pH from about 8 to 9.

In various embodiments, the aqueous composition comprising submicron particles is a colloidal dispersion stable to agglomeration and/or settling for a period of at least 1, 2, 3, 4, 5, 6, or 7 days under standard conditions (that is, at 25° C. and atmospheric pressure).

In various embodiments, the colloidal dispersion is stable to agglomeration and/or settling for a period of at least 1, 2, 3, 4, 5, 6, 7, 8, 9, 10, 11, or 12 months under standard conditions.

In various embodiments, the precipitation is carried out at a temperature from 0 and 80° C.

In certain embodiments, the precipitation is carried out at ambient temperature.

In various embodiments, the method further comprises concentrating the aqueous composition comprising submicron particles.

In various embodiments, the aqueous composition comprising submicron particles is concentrated by centrifugation.

In various embodiments, the aqueous composition comprising submicron particles is dewatered to form a slurry and/or dried to form a powder.

In various embodiments, the composition comprising submicron particles is a biocidal composition.

In certain embodiments, the biocidal composition is a dispersion, such as colloidal dispersion, comprising submicron particles of a salt of copper, zinc or a combination thereof.

In exemplary embodiments, the biocidal composition is a dispersion comprising submicron particles of basic copper carbonate.

In exemplary embodiments, the dispersion is an aqueous dispersion.

In various embodiments, the biocidal composition further comprises one or more co-biocide.

In various embodiments, the composition comprising submicron particles further comprises one or more biocide.

In various embodiments, the biocide is a fungicide, insecticide, moldicide, bactericide, or algicide.

In various embodiments, the method further comprises admixing one or more biocide and the composition comprising submicron particles.

In various embodiments the biocide is in the form of a solution, an emulsion, a microencapsulation, or as submicron particles.

In various embodiments, the biocide is an organic biocide.

In various embodiments, the method comprises admixing (that is, admixing the composition comprising the submicron particle with) a solution comprising the organic biocide and one or more organic solvent.

In various embodiments, the organic biocide is fungicide including one or more of chlorothalonil, lodopropynylbutylcarbamate, or the like, insecticides including bifenthrin, deltamethrin, permethrin, imidacloprid or the like, bactericides and the like or mixtures thereof. Such list is to be interpreted as illustrative rather than restrictive.

In various embodiments, the composition comprising submicron particles further comprises submicron particles of the one or more biocide.

In certain embodiments, the composition comprises submicron particles of basic copper carbonate and submicron particles or a micro-emulsion of tebuconazole or propiconazole or a combination thereof.

In certain embodiments, the composition comprises submicron particles of basic copper carbonate and submicron particles of chlorothalonil.

In certain embodiments, the composition comprises submicron particles of basic copper carbonate and a quaternary ammonium compound, tertiary amine, or tertiary amine oxide.

In various embodiments, the composition comprises a borate and submicron particles of basic copper carbonate.

In certain embodiments, the composition comprises submicron particles of basic copper carbonate and submicron particles of an insecticide (such as Bifenthrin). Such compositions may be used for treating plants or included in a resin used in preparation of plywood or laminated veneer lumber.

In various embodiments, the organic solvent comprising the organic biocide is miscible in water.

In various embodiments, the organic solvent is an alcohol (for example, a C1-6alcohol), a ketone, a lactam, glycol ether, or a combination of any two or more thereof.

In various embodiments, the C1-6alcohol is methanol, ethanol, or a combination thereof.

In various embodiments, the composition comprising submicron particles is a pigment composition comprising submicron particles of a pigmented metal salt.

In various embodiments, the submicron particles reflect or absorb light in the visible wavelength range such that the composition is coloured.

In various embodiments, the composition comprising submicron particles is a catalyst composition comprising submicron particles of a metal salt having catalytic properties.

In certain embodiments, the method comprises:

providing an aqueous alkaline solution comprising a metal, one or more ligand that forms a soluble complex with the metal under alkaline conditions, optionally one or more dispersant, and optionally a source of one or more weak acid, wherein the metal is copper (II) or zinc (II) and the one or more ligand is selected from ammonia, an amine, and a glycol such that the soluble metal complex is a metal-ammine, metal-amine, or metal-glycol complex;

admixing the solution and a source of carbon dioxide to reduce the pH of the solution such that submicron particles of a metal salt precipitate, thereby providing an aqueous composition comprising submicron particles of the metal salt,
wherein the aqueous composition is a colloidal dispersion or is deflocculated to provide a colloidal dispersion.

In certain embodiments, the method comprises:
providing an aqueous alkaline solution comprising a metal, one or more ligand that forms a soluble complex with the metal under alkaline conditions, and one or more dispersant, wherein the metal is copper (II) or zinc (II) and the one or more ligand is selected from ammonia, an amine, and a glycol such that the soluble metal complex is a metal-ammine, metal-amine, or metal-glycol complex;
admixing the solution, a source of carbon dioxide, and optionally a source of one or more weak acid to reduce the pH of the solution such that submicron particles of a metal salt precipitate, thereby providing an aqueous composition comprising submicron particles of the metal salt,
wherein the aqueous composition is a colloidal dispersion or is deflocculated to provide a colloidal dispersion.

In certain embodiments, the method comprises:
providing an aqueous alkaline solution comprising a metal, one or more ligand that forms a soluble complex with the metal under alkaline conditions, and optionally one or more dispersant, wherein the metal is copper (II) or zinc (II) and the one or more ligand is selected from ammonia, an amine, and a glycol such that the soluble metal complex is a metal-ammine, metal-amine, or metal-glycol complex;
admixing the solution and a source of carbon dioxide to reduce the pH of the solution such that submicron particles of a carbonate of the metal precipitate and/or submicron particles of a borate of the metal precipitate, thereby providing an aqueous composition comprising submicron particles of a carbonate of the metal and/or submicron particles of a borate of the metal;
wherein the aqueous composition comprising submicron particles is a colloidal dispersion or is deflocculated to provide a colloidal dispersion.

In certain embodiments, the method comprises:
providing an aqueous alkaline solution comprising a metal, one or more ligand that forms a soluble complex with the metal under alkaline conditions, and optionally one or more dispersant, wherein the metal is copper (II) or zinc (II) and the one or more ligand is selected from ammonia, an amine, and a glycol such that the soluble metal complex is a metal-ammine, metal-amine, or metal-glycol complex;
admixing the solution and a source of carbon dioxide to reduce the pH of the solution such that submicron particles of a carbonate of the metal precipitate, thereby providing an aqueous composition comprising submicron particles of a carbonate of the metal; and
optionally treating the aqueous composition comprising submicron particles of a carbonate of the metal with a base to provide an aqueous composition comprising submicron particles of a hydroxide of the metal; and/or
optionally heating the aqueous composition comprising submicron particles of a carbonate of the metal or the aqueous composition comprising submicron particles of a hydroxide of the metal to provide an aqueous composition comprising submicron particles of an oxide of the metal,
wherein the aqueous composition(s) comprising submicron particles (that is, the composition comprising submicron metal carbonate particles, composition comprising submicron metal hydroxide particles, and/or composition comprising submicron metal carbonate particles) is a colloidal dispersion or is deflocculated to provide a colloidal dispersion.

In certain embodiments, the method comprises:
providing an aqueous alkaline solution comprising a metal, one or more ligand that forms a soluble complex with the metal under alkaline conditions, and one or more dispersant, wherein the metal is copper (II) or zinc (II) and the one or more ligand is selected from ammonia, an amine, and a glycol such that the soluble metal complex is a metal-ammine, metal-amine, or metal-glycol complex;
admixing the solution and a source of carbon dioxide to reduce the pH of the solution such that submicron particles of a carbonate of the metal precipitate, thereby providing an aqueous composition comprising submicron particles of a carbonate of the metal; and
optionally treating the aqueous composition comprising submicron particles of a carbonate of the metal with a base to provide an aqueous composition comprising submicron particles of a hydroxide of the metal; and/or
optionally heating the aqueous composition comprising submicron particles of a carbonate of the metal or the aqueous composition comprising submicron particles of a hydroxide of the metal to provide an aqueous composition comprising submicron particles of an oxide of the metal,
wherein the aqueous composition(s) comprising submicron particles (that is, the composition comprising submicron metal carbonate particles, composition comprising submicron metal hydroxide particles, and/or composition comprising submicron metal carbonate particles) is a colloidal dispersion or is deflocculated to provide a colloidal dispersion.

In various embodiments, the method is for producing a composition comprising submicron particles of a carbonate, hydroxide, oxide, or borate of the metal.

In various embodiments, the method is for producing a composition comprising submicron particles of a carbonate, hydroxide, or oxide of the metal.

In various embodiments, the composition, when tested using the AWPA E12 corrosion standard method, compared to standard ACQ, results in an mpy that is at least 20% less, for example at least 30% less, at least 40% less, at least 50% less, at least 60% less, at least 70% less, at least 80% less, or at least 90% less. In various embodiment, the mpy is at least 60% less. In another embodiment, the composition exhibits no corrosion.

In another aspect, the present invention provides a composition comprising submicron particles of a metal salt prepared by a method according to the present invention.

In another aspect, the present invention provides a method of treating a substrate, the method comprising applying to the substrate a composition comprising submicron particles of a metal salt prepared by a method according to the present invention.

In various embodiments, the composition is applied to the substrate by dipping, deluging, spraying, brushing, mixing, or positive pressure impregnation, vacuum pressure impregnation, or variations thereof.

In various embodiments, applying the composition to the substrate imparts the substrate with biocidal properties, pigmenting properties or catalytic properties.

In various embodiments, applying the composition to the substrate imparts colour or water repellence to at least a target zone of the substrate.

In certain embodiments, the treatment is to protect the substrate from or remove or prevent or ameliorate growth of pest organisms on or within the substrate.

In various embodiments, the substrate to be treated is organic.

In various embodiments, the substrate is a lignocellulosic substrate.

In other embodiments, the substrate is inorganic, for example concrete or stone.

In various embodiments, the composition is applied to the substrate at ambient temperature.

In various embodiments, the composition is stable at the temperature of the substrate at the time of application.

In another aspect, the present invention provides a substrate treated according to a method of treating a substrate according to the present invention.

As used herein, the term “and/or” means “and”, or “or”, or both.

The term “comprising” as used in this specification means “consisting at least in part of. When interpreting each statement in this specification that includes the term “comprising”, features other than that or those prefaced by the term may also be present. Related terms such as “comprise” and “comprises” are to be interpreted in the same manner.

The invention may also be said broadly to consist in the parts, elements and features referred to or indicated in the specification of the application, individually or collectively, in any or all combinations of two or more of said parts, elements or features, and where specific integers are mentioned herein which have known equivalents in the art to which the invention relates, such known equivalents are deemed to be incorporated herein as if individually set forth.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9, and 10) and also any range of rational numbers within that range (for example, 2 to 8, 1.5 to 5.5, and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

Although the present invention is broadly as defined above, those persons skilled in the art will appreciate that the invention is not limited thereto and that the invention also includes embodiments of which the following description gives examples.

### BRIEF DESCRIPTION OF THE FIGURES

The invention will now be described with reference to the Figures in which:

FIG. 1 is photograph of a sample of the submicron particle dispersion of copper carbonate prepared in Example 1 showing that the dispersion is optically transparent.

FIG. 2 is a photograph of a sample of the submicron particle dispersion of copper carbonate prepared in Example 1 showing the turbidity observed when a beam of light from an LED light source is passed through the sample.

FIG. 3 is a graph showing the particle size distribution of the dispersion formed in Example 1.

FIG. 4 is a scanning electron micrograph (SEM) of the particles of the dispersion formed in Example 7.

### DETAILED DESCRIPTION OF INVENTION

The present inventor has unexpectedly found that submicron particle biocides, pigments and catalysts can be prepared simply and effectively by precipitation from aqueous alkaline solutions of metal complexes optionally comprising one or more dispersant.

The submicron particles can be manufactured using simple inexpensive plant and equipment without use of expensive milling equipment, incurring high energy costs or cooling costs, and the need for large volumes of solvents or surfactants. The submicron particles can conveniently be manufactured in smaller manufacturing units either near to or at the place of final use.

Whereas biocide compositions, particularly submicron particle compositions, prepared by wet milling must be prepared in a manufacturing unit focused on producing large volumes to minimise cost, compositions of this invention can be produced simply and economically at the site of use.

Accordingly, in one aspect, the present invention relates to a method of preparing a composition comprising submicron particles of a metal salt. Broadly, the method comprises the steps of:
providing an aqueous alkaline solution comprising a metal, one or more ligand that forms a soluble complex with the metal under alkaline conditions, and optionally one or more dispersant; and
admixing the solution and a source of carbon dioxide to reduce the pH of the solution such that submicron particles of a metal salt precipitate, thereby providing an aqueous composition comprising submicron particles of the metal salt.

In another aspect, the present invention relates to a method of preparing a composition comprising submicron particles of a metal salt, the method comprising:
providing an aqueous alkaline solution comprising a metal, one or more ligand that forms a soluble complex with the metal under alkaline conditions, and one or more dispersant; and
admixing the solution and a source of carbon dioxide to reduce the pH of the solution such that submicron particles of a metal salt precipitate, thereby providing an aqueous composition comprising submicron particles of the metal salt.

As used herein, the term “submicron particles” refers to particles having no dimension on any one side which is greater than or equal to one micron. As used herein, the term “particle size” refers to the size of the largest dimension of the particle.

Particle size can be measured using techniques known to those skilled in the art, such as, laser diffraction, photon correlation spectroscopy, sedimentation field flow fractionation, disk centrifugation or electrical sensing zone. In various embodiments, the “submicron particles” have a particle size of at least 0.005 microns and less than 1 micron, for example at least 0.01 microns and less than 1 micron. The aqueous composition comprising the submicron particles of a metal salt may comprise particles having a particles greater than 1 micron. However, in certain embodiments, the amount of such particles present is preferably low, for example less than 30%, 20%, 10%, or less than 5% of the particles are greater than 1 micron.

The metal may be a transition metal selected from the first, second, or third transition series. The metal may be in any suitable oxidation state. In exemplary embodiments, the metal is zinc or copper, for example Zn (II) or Cu (II).

The method can be used to provide compositions comprising submicron particles of a variety of different metal salts, for example metal carbonates, hydroxides, oxides, and borates.

In certain embodiments, the metal salt is a copper carbonate, copper hydroxide, copper oxide, copper borate, zinc carbonate, zinc hydroxide, zinc oxide, or zinc borate. In certain embodiments, the metal salt is a copper carbonate, copper hydroxide, copper oxide, zinc carbonate, zinc hydroxide, or zinc oxide. In certain embodiments, the metal salt is a copper carbonate, copper hydroxide, copper oxide, or zinc carbonate. In certain exemplary embodiments, the metal salt is basic copper carbonate. In other exemplary embodiments, the metal salt is zinc carbonate.

The composition comprising submicron particles prepared by the method can be provided in the form of a mobile fluid such as a colloidal dispersion, a slurry, or a powder. The composition can also be converted into granules. In certain embodiments, the composition is provided in the form of an aqueous fluid having active components which are non-volatile at the temperature at the time of application.

To provide a slurry or a powder, the aqueous composition comprising submicron particles may be concentrated to reduce the amount of liquid in the composition. The composition can be concentrated by various means including centrifugation, filtration, dialysis, osmosis, electrophoresis or the like. Soluble ions such as chloride, nitrate, sulphate, sodium, potassium and the like may be removed by dialysis or by centrifugation and washing. Concentrating may involve dewatering to form a slurry and/or drying to form a powder.

The composition can be provided in the form of the dispersion. The term “dispersion” as used herein, unless indicated otherwise, refers to a homogeneous fluid or powder wherein submicron particles of the metal salt are dispersed uniformly throughout the powder or fluid.

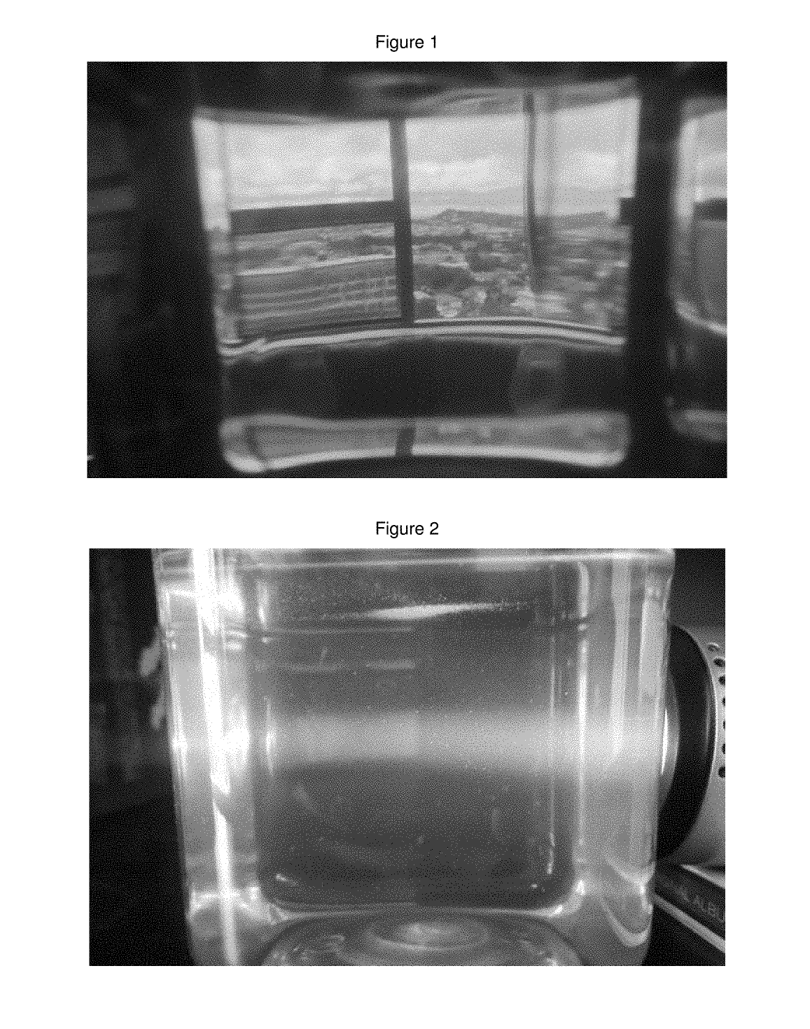

In certain embodiments, the aqueous composition comprising submicron particles is a colloidal dispersion. The dispersion comprises an aqueous continuous phase and a discontinuous phase comprising the submicron particles of the metal salt. Typically a colloid or colloidal dispersion comprises particles having a particle a size from about 1 to about 1000 nanometres. A transparent colloid typically has particles having a particle size of less than 700 nanometres. The presence of a colloid can be confirmed by observation of the Tyndall effect. In the Tyndall effect, light from a light beam is scattered as the beam passes through a colloid by particles in the colloid that are otherwise invisible to the naked eye (as seen in FIGS. 1 and 2).

The aqueous composition can comprise flocculated submicron particles of the metal salt. In such embodiments, the method may further comprise the step of deflocculating the composition to provide a colloidal dispersion. Deflocculation (or peptisation) may be carried out by any suitable means, for example by sonicating the composition or diluting the composition, for example with further components of the liquid phase (such as additional water or dispersant). Deflocculation may also be carried out by admixing one or more deflocculant.

The composition may be in form of a concentrate or ready to use formulation, for example a composition suitable for direct application to a substrate such as lumber. In various embodiments, the concentrate comprises from about 0.1 to 30% water by weight of the composition, for example from 0.1 to 25, 0.1 to 20, 0.1 to 15, 0.1 to 10, 0.1 to 5, 0.5 to 30, 0.5 to 25, 0.5 to 20, 0.5 to 15, 0.5 to 10, 0.5 to 5, 1 to 30, 1 to 25, 1 to 20, 1 to 15, 1 to 10, or 1 to 5% water by weight of the composition, and useful ranges may be selected from any two of these values. In various embodiments, the ready to use formulation comprises from about 80 to 99.5% water by weight of the composition, for example from 85 to 99.5, 90 to 99.5, or 95 to 99.5% water by weight of the composition, and useful ranges may be selected from any two of these values.

The amount of metal salt in the composition can vary depending the desired application. In various embodiments, the composition comprises from about 50 to 95% metal salt by weight of the composition on a dry basis, for example from 50 to 90, 50 to 85, 50 to 80, 50 to 75, 55 to 95, 55 to 90, 55 to 85, 55 to 80, 55 to 75, 60 to 95, 60 to 90, 60 to 85, 60 to 80, 60 to 75, 65 to 95, 65 to 90, 65 to 85, 65 to 80, 65 to 75, 70 to 95, 70 to 90, 70 to 85, 70 to 80, or 70 to 75% metal salt by weight of the composition on a dry basis, and useful ranges may be selected from any two of these values.

The aqueous composition may comprise one or more organic solvent and/or one or more surfactant. The organic solvent may be polar, nonpolar, water miscible, or water immiscible.

The composition can be a biocidal composition comprising submicron particles of a biocidal metal salt. Biocidal compositions of the present invention may contain polar and/or non-polar solvents and the like, or surfactants or dispersants to impart particular properties to final biocide composition when required. Persons skilled in the art will appreciate various compositions that may be applicable to the invention.

By way of example, impregnation of lumber might be achieved by a variation of vacuum or pressure of a fluid containing the biocide of this invention. Alternatively a plant might be sprayed with a fluid containing the biocide of this invention. Where it is desired that the substrate has water repellent properties or a different colour, compositions may include those of use in waterproofing a substrate, or compositions containing certain dyes or pigments to colour the substrate may be used.

Alternatively, the composition may be a pigment composition or a catalyst composition. The pigment composition comprises submicron particles of a pigmented metal salt. The catalyst composition comprises submicron particles of a metal salt having catalytic properties.

Suitable pigments include but are not limited to copper carbonate which is green, zinc carbonate which is white, nickel carbonate which is pale green, copper oxide which is black, and copper borate which is green. All such salts can be used in ceramics and also as catalysts. Such pigments can be included in wood preservatives to enhance the colour of the treated wood.

Transition metal oxides are used as catalysts. Examples include nano-particulate copper oxide and nickel oxide, which is used in the catalytic oxidation of methanol. Catalysts for reaction of carbon monoxide and hydrogen include zinc oxide and copper oxide. Nano-particulate metal oxides can be prepared by heating metal carbonates as described herein.

The aqueous composition comprising submicron particles in the form of a colloidal dispersion can be stable to agglomeration and/or settling. The dispersion can be stable for a period of at least 1, 2, 3, 4, 5, 6, or 7 days or 1, 2, 3, 4, 5, 6, 7, 8, 9, 10, 11, or 12 months under standard conditions—i.e. at ambient temperature (25° C.) and atmospheric pressure.

One or more dispersant may be present in the composition to stabilise the submicron particles, for example from settling and/or aggregation. The quantity of dispersant, the type of dispersant and the timing of addition, can be used to adjust the particle size and stability of the composition.

The aqueous composition may comprise one or more dispersant. Any suitable amount of dispersant may be present in the composition. In various embodiment, one or more dispersant is present in an amount effective to provide a stable colloidal dispersion of the aqueous composition.

In various embodiments, the composition comprising the submicron particles comprises from about 5 to 50% of the one or more dispersant by weight of the composition on a dry basis, for example from about 5 to 45, 5 to 40, 5 to 35, 5 to 30, 5 to 25, 5 to 20, 5 to 15, 10 to 50, 10 to 45, 10 to 40, 10 to 35, 10 to 30, 10 to 25, 10 to 20, or 10 to 15% of the one or more dispersant by weight of the composition on a dry basis, and useful ranges may be selected from any two of these values. In various embodiments, the composition comprises from about 5 to 50% of the one or more dispersant by weight of the composition on a dry basis.

The dispersant can be one of a range of dispersants known to those versed in the art. The dispersant can be an organic dispersant, which may be anionic, cationic, non-ionic, or zwitterionic. In some embodiments, the dispersant is a polymer, such as an anionic, cationic, non-ionic, or zwitterionic polymer. For example, the dispersant could be an anionic dispersant such as a polycarboxylate, naphthalene sulphonate formaldehyde condensate, a lignosulphonate, a melamine sulphonate formaldehyde condensate, an alkyl-aryl ether phosphate, or an alkyl ether phosphate, a cationic dispersant, or non-ionic such as a polyether, including mixed polyether, or polyvinylpyrrolidone, or a zwitterionic dispersant such as a zwitterionic polymer, or a combination of any two or more thereof. Examples of cationic dispersants include but are not limited to dialkylamino substituted acrylates, such as dimethylamino substituted acrylates, polyethyleneimines and the like. The anionic dispersant can include sulphate, sulphonate, phosphonate, phosphate or carboxylic groups.

The composition can also comprise one or more surfactant. The one or more surfactant may further stabilise the submicron particles in the composition. The surfactant can be selected based on compatibility with one or more dispersant.

Any suitable surfactant may be used. The surfactant can be an organic surfactant, which may be anionic, cationic, non-ionic, or zwitterionic. Examples include but are not limited to anionic surfactants such as dodecylbenzenesulphonate, lauryl sulphate, or dodecylsulphate, cationic surfactants such as benzalkonium chloride or hexadecyltrimethylammonium bromide, non-ionic surfactants such as polyvinylpyrrolidone, nonylphenolethoxylate or octylphenol ethoxylate, a zwitterionic surfactants, and the like.

In addition to submicron particles of the metal salt, which may be biocidal, the composition may comprise one or more biocide. Biocides and/or co-biocides can be included to achieve specific purposes such as extending the range of organisms that the composition can control.

The composition comprising submicron particles of the metal salt may be admixed with one or more biocide in the form of a solution, an emulsion, a microencapsulation, or submicron particles. A biocide in the form of a solution may comprise the biocide and one or more organic solvent.

Examples of biocides include but are not limited to fungicides, insecticides, moldicides, bactericides, algaecides, etc. The biocide can be an organic biocide or an inorganic biocide, such as a borate.

Organic biocides are well known to those skilled in the art and include, for example, azoles, quaternary ammonium compounds, fluoride compounds and combinations thereof. The organic biocide can be a fungicide including one or more of chlorothalonil, iodopropynylbutylcarbamate, a quaternary ammonium compound, a triazole compound, or the like, insecticides including bifenthrin, deltamethrin, permethrin, imidacloprid or the like, bactericides and the like or mixtures thereof.

The biocide may be water soluble or water insoluble. Examples of water soluble biocides include quaternary ammonium compounds, for example alkyldimethylbenzylammonium chloride, dimethyldidecylammonium chloride, dimethyldidecylammonium carbonate/bicarbonate and the like. Examples of water insoluble biocides include, but are not limited to, azoles, for example cyproconazole, propiconazole, tebuconazole, (TCMTB), 2-(thiocyanatomethylthio), benzothiazole, chlorothalonil, and dichlofluanid, isothiazolones, for example Kathon 930, Kathon WT, methylisothiazolinone, benzisothiazolin-3-one, and 2-octyl-3-isothiazolone, imidacloprid, iodopropynyl butylcarbamate (IPBC), pyrethroids, for example, bifenthrin, cypermethrin, and permethrin, chlorpyrifos, 4-cumylphenol, fipronil, carbendazim, cyfluthrin, and 4-alpha-cumylphenol.

In various embodiments, the biocide is a fungicide. In various embodiments, the fungicide is selected from the group of fungicides active against wood-rotting basidiomycetes. In various embodiments the fungicide comprises one or more fungicides selected from the group of conazoles and ergosterol biosynthesis inhibitors to prevent the growth of white rot, brown rot, and soft rot fungi, which are the major causes of wood decay in untreated wood. Examples of conazoles include climbazole, clotrimazole, imazalil, oxpoconazole, prochloraz, triflumizole, azaconazole, bromuconazole, cyproconazole, diclobutrazol, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole, uniconazole, and uniconazole-P. Examples of ergosterol biosynthesis inhibitors include morpholine fungicides, for example aldimorph, benzamorph, carbamorph, dimethomorph, dodemorph, fenpropimorph, flumorph, and tridemorph. Examples of other fungicides that have been found to be effective against one or more wood-rotting fungi include carboxin, iprodione, fenpiclonil, ferbam, fenpiclonil, capafol, 8-hydroxyquinoline, nabam, oxycarboxin, cyprodinil, chlorothanil, axaoxystrobin, trifloxystrobin, thiram, fluazinam, terrazole, carbendazim, and benomyl. These fungicides can be used in combination with one or more conazoles or ergosterol biosynthesis inhibitors in the invention.

In various embodiments, the biocide is an insecticide. Examples of insecticides include pyrazolines, indazoles, oxyindazoles, pyrazoline carboxanilides, pyridazines, oxadiazines, tricyclic pyridazines, tricyclic oxadiazines, tricyclic triazines, carbamates, organophosphates (for example, chlorpyrifos and dichlorvos), fenvalerate, fipronil, and indoxacarb and its metabolite, and mixtures thereof.

The biocide may be selected from fungicides such as the group comprising benzimidazoles, substituted morpholines, triazoles which can include the likes of propiconazole, tebuconazole, hexaconazole and others, diazoles which can include the likes of prochloraz, phthalonitriles, quaternary ammonium compounds, isothiazolinones, guazatines, dodine, methylene bisthiocyanate, orthophenylphenol, tertiary amine oxides such as alkyldimethyl amine oxide, iodine containing fungicides, and the like. The biocide may be selected from insecticides such as the group of synthetic pyrethroids such as bifenthrin, delatmethrin, permethrin and the like or imidacloprid. Other suitable options will be known to those versed in the art. Many biocides are known to those versed in the art including those used in wood preservation or agriculture.

In various embodiments, the one or more biocides comprise a quaternary ammonium compound, a boron compound, a fluoride compound or an azole.

In various embodiments, the quaternary ammonium compound is a benzalkonium salt or dimethyldidecylammonium salt. In various embodiments, the quaternary ammonium compound is a benzalkonium chloride or dimethyldidecylammonium chloride. In various embodiments, the quaternary ammonium compound is didecyldimethylammonium carbonate or bicarbonate.

In one embodiment, the azole is propiconazole or tebuconazole or a combination thereof.

In one embodiment the one or more biocide is an insecticide, such as permethrin or bifentrhin, or fungicide, such as chlorothalonil.

In one embodiment, the composition includes an amine oxide or an alkoxylated amine, which can facilitate distribution of the biocides within substrates such as lumber.

Biocides having low solubility in the composition can be incorporated as micronized particles, as emulsions or micro-emulsions or as encapsulated or micro-encapsulated particles. In various embodiments, the composition comprises submicron particle biocides, micro-emulsions of biocides or micro-encapsulated biocides.

Whilst not wishing to be bound by any particular theory, the inventor believes that in the method of the present invention submicron particles of a metal compound are created by precipitation on reducing the pH of the aqueous alkaline solution comprising the metal in the form of a soluble complex using a carbon dioxide source. In certain embodiments, the carbon dioxide converts the metal in the aqueous alkaline solution to a carbonate. Thus, in various embodiments, admixing the solution and the source of carbon dioxide reduces the pH of the solution such that submicron particles of a metal carbonate precipitate.

In various embodiments, admixing the solution and the source of carbon dioxide reduces the pH of the solution such that submicron particles of a metal borate precipitate. In some of such embodiments, the aqueous solution from which the submicron particles are precipitated comprises borate ions. In some of such embodiments, submicron particles of a metal carbonate and submicron particles of a metal borate precipitate and/or submicron particles of both a metal carbonate and a metal borate precipitate.

The submicron particles of a metal salt comprise the metal salt. It will be appreciated that an individual submicron particle of a metal salt may comprise other co-precipitated components. For example, in some embodiments, submicron particles of a metal borate may comprise individual submicron particles comprising both the metal borate and an amount of a co-precipitated metal carbonate.

In some embodiments, the submicron particles consist of or consist essentially the metal salt. For example, in some embodiments, submicron particles of a metal carbonate consist of or consist essentially of the metal carbonate. In some embodiments, the submicron particles of a metal salt comprise at least 75, 80, 85, 90, 95, 97, 98, 99, or 100% of the metal salt by weight of the particles.

The metal complex is soluble under the alkaline conditions of the alkaline solution, but in certain embodiments is unstable at neutral pH. The soluble metal complex may be decomposed on reducing the pH of the alkaline solution by admixing the source carbon dioxide. The soluble metal complex may be decomposed by reaction with the carbon dioxide provided by the source of carbon dioxide. For example, one or more ligand of the soluble metal complex may react with the carbon dioxide as described herein.

One or more ligand of the soluble metal complex may be released from the soluble metal complex by decomposition of the soluble metal complex. Alternatively or additionally, a salt of one or more ligand of the soluble metal complex may be produced by decomposition of the soluble metal complex. In certain embodiments, the one or more ligand released by decomposition of the soluble metal complex is a glycol. In certain embodiments, the salt of the one or more ligand thereof produced by decomposition of the soluble metal complex is ammonium carbonate (the ligand being ammonia) or a carbonate of an amine (the ligand being an amine). Such salts may be produced by the reaction of ammonia ligand or amine ligand with a stoichiometric amount carbon dioxide.

Without wishing to be bound by theory, the inventor believes that the one or more ligand released or salt thereof produced by decomposition of the soluble metal complex may reduce or prevent aggregation and/or settling of the submicron particles. As such, the one or more ligand released or salt thereof produced is capable of acting as a deflocculant to stabilise the submicron particles.

While it is generally desirable to minimise costs to use the minimum stoichiometric amount of the one or more ligand necessary form the soluble metal complex as described herein, in certain embodiments an excess may be used. It will be apparent that such excess (or free or uncoordinated) ligand present in the aqueous alkaline solution and/or salts thereof (e.g. produced by reaction with carbon dioxide) may also reduce or prevent aggregation and/or settling of the submicron particles in the aqueous composition.

The reaction may be carried out under conditions optimised to maximise the amount of submicron particles formed. However, it will be appreciated that, in certain embodiments, the aqueous composition may comprise unreacted starting material, for example trace amounts of undecomposed soluble metal complex.

Admixing the aqueous alkaline solution and source of carbon dioxide can be carried out under vigorous agitation, although in some embodiments the agitation need not be vigorous. Those skilled in the art can readily determine the degree of agitation required having regard to the nature of the reactants and the processing conditions. Vigorous agitation can be provided by a high speed stirrer, a mixer commonly known as Silverson, sonication or the like. The agitation can be high shear agitation.

The carbon dioxide source provides carbon dioxide to the aqueous solution. Depending on the source used, carbon dioxide may be introduced directly into the reaction or generate in situ. Any suitable source of carbon dioxide may be used. In various embodiments the source of carbon dioxide is carbon dioxide gas, a solution comprising carbon dioxide, or a latent source of carbon dioxide.

Carbon dioxide gas may be admixed with the alkaline solution by, for example, bubbling the gas through the alkaline solution, with agitation. In various embodiments, carbon dioxide gas may be admixed with the alkaline solution under pressure in a suitable reactor, for example a high pressure reactor. Liquid carbon dioxide may also be used as a source of carbon dioxide in certain embodiments where the admixing is carried out under pressure (that is, at a pressure greater than atmospheric pressure, in order to maintain the carbon dioxide in a liquid state) in a suitable reactor, for example a high pressure reactor.

Solutions comprising carbon dioxide may be saturated with carbon dioxide. The solution comprising carbon dioxide may be an aqueous solution. Such solutions may be prepared at low temperature to increase the amount of carbon dioxide that may be dissolved in the solution. Methods of preparing solutions comprising carbon dioxide will be apparent to those skilled in the art.

Latent sources of carbon dioxide include, for example organic carbonates that decompose under the reaction conditions to provide carbon dioxide, such as ethylene carbonate or dimethyl carbonate. To increase the rate of decomposition of the organic carbonates to carbon dioxide, the reaction mixture may be heated.

The carbon dioxide source may be admixed with the solution at a controlled rate, for example slowly, to achieve the desired pH. The pH may be monitored during the admixing step.

Admixing the solution and source of carbon dioxide to reduce the pH of the alkaline solution such that submicron particles of the metal salt precipitate may be carried out at any suitable temperature, for example a temperature from 0 to 80° C. Advantageously, in certain embodiments the precipitation may be carried out at ambient temperature.

Admixing the solution and source of carbon dioxide may reduce the pH of the solution such that submicron particles of a metal carbonate precipitate.

The aqueous alkaline solution may further comprises a source of one or more acid, such as a source of one or more weak acid. In some embodiments, the source of the one or more acid, such as a source of one or more weak acid, may be introduced to the solution prior to, during, or after formation of the soluble metal complex, provided that the one or more acid does not prevent formation of the soluble metal complex or decompose the soluble metal complex. In certain embodiments, the one or more acid may be admixed prior to, during, or after admixing one or more optional dispersant. In some embodiments, the one or more acid is admixed with the aqueous alkaline precursor solution.

In some embodiments, the method may comprise admixing the solution, the source of carbon dioxide, and a source of one or more acid in any order. The one or more acid can be a weak acid. A weak acid is an acid that is only partially dissociated in aqueous solution. That is, only a portion of the weak acid releases its protons in solution. By contrast, a strong acid is completely dissociated in aqueous solution. The acid dissociation constant (Ka) for an acid indicates the extent to which an acid dissociates in solution. The acid dissociation constant can be expressed as a pKa. The weak acid may be a weak acid having a pKa of at least about 6. The weak acid may be a weak acid that forms a salt with the metal that in water at pH 7 is substantially insoluble. It will be appreciated that the submicron particles formed in such embodiments of the method may comprise a metal salt of the weak acid.

Examples of weak acids include but are not limited to boric acid and phenols, such as orthophenyl phenol, phenol, cresol, xylenol, thymol and the like. In certain exemplary embodiments the source of the weak acid is boric acid or a borate, such as borax.

The metal salt precipitated in the method is substantially insoluble in water. The metal salt can have a solubility of less than 0.1 g/L and 20° C. Preferably the metal salt has a solubility of less than 0.01 g/L a 20° C.

Generally biocides used for protection of wood or plants for example have low solubility once applied. Otherwise they will be lost to the environment when exposed to water such as for example rain. Certain such biocides have low solubility but sufficient to allow uptake by insects, fungi and the like. Examples include copper carbonate with Ksp (solubility product in water) of 1 0.4×10⁻¹⁰, zinc carbonate a Ksp of 1.4×10⁻¹¹, and copper hydroxide a Ksp of 2.2×10⁻²°.

Where the composition comprises submicron particles of a metal carbonate, the method may further comprise treating the composition with a base to convert the metal carbonate particles to submicron particles of a metal hydroxide. The base used for the conversion may be an alkali or alkaline earth metal hydroxide. The reaction may advantageously be carried out at ambient temperature.

Where the composition comprises submicron particles of a metal carbonate or a metal hydroxide, the method may further comprise heating the composition to convert to the metal carbonate particles or metal hydroxide particles to submicron particles of an oxide of the metal. The composition may be heated at any suitable temperature, for example a temperature from about 50 to about 95° C. In certain exemplary embodiments, the composition is heated at a temperature of about 80° C.

The method may further comprise admixing the aqueous composition comprising the submicron particles produced on reducing the pH of the solution and one or more dispersant or additional dispersant and/or one or more surfactant or additional surfactant to increase the stability of the submicron particles in the composition, for example to settling and/or agglomeration.

Depending on the desired application for the composition, the method may further comprise adjusting the pH of the composition comprising submicron particles by admixing one or more acid or base, for example a weak acid or base. The admixed acid or base may act as a pH buffer. In some embodiments, the pH is adjusted by admixing one or more acid and one or more base.

In certain embodiments, the pH of the composition may be adjusted by admixing boric acid and/or a borate, such as borax. in some embodiments addition of borate (e.g. subsequent to formation of the precipitate) may result in a composition containing free borate ions. Accordingly, in some embodiments, the aqueous composition comprises borate ions.

As described in the Examples, the inventor has found that using borax as a buffer the pH of the composition can be adjusted to about pH 9. Sodium tetraborate (borax) is also a corrosion inhibitor and so may reduce the corrosivity of the composition.

The pH of the composition may be adjusted to a pH from about 6 to about 10. In some embodiments, the pH of the aqueous composition may be adjusted to a final pH of from about 7.5 to about 9.5, such as from about 8 to 9. The pH may be monitored during this pH adjustment (and may be monitored in any other step described herein in which pH is changed). Suitable methods for monitoring pH are known to those skilled in the art.

In some embodiments, the pH of the alkaline solution is reduced to a pH (e.g. a pH from about 7.5 to 9.5, such as from about 8 to 9) such that submicron particles of the metal salt precipitate, thereby forming an aqueous composition of such a pH comprising the submicron particles having a pH suitable for the desired application. In such embodiments, no subsequent pH adjustment step may be necessary.

Without wishing to be bound by theory, the inventor believes that at a pH from about 7.5 to about 9.5, such as about from 8 to 9, the solubility of the metal salt precipitated (e.g. copper carbonate) is low. In addition, the inventor believes that at such a pH the corrosivity of the composition is also low, as there is little ionic metal in solution. Such a pH may also be useful for reducing or minimising leaching and/or loss of the metal (e.g. copper) from substrates treated with the composition, such as lumber and other lignocellulosic substrates.

For example, in certain embodiments the composition may have a pH from about 8 to 9 and comprise submicron particles of a copper salt in the form of basic copper carbonate.

The inventor has found that at least in certain embodiments the aqueous composition produced by the method can have low corrosivity. In various embodiments, the composition, when tested using the AWPA E12 corrosion standard method, compared to standard ACQ, results in an mpy that is at least 20% less. Whilst the AWPA E12 corrosion standard method may not specify the amount of copper added to the wood, those versed in the art will know the typical incorporation rates and will also know that higher loadings will exacerbate corrosion proportionately. Any suitable standard ACQ may be used for comparison. In some embodiments, the standard ACQ is type A, B, C, or D. In certain preferred embodiments, the comparison is to ACQ Type B.

The aqueous alkaline solution comprises a metal, one or more ligands that forms a soluble complex with the metal under alkaline conditions, and optionally one or more dispersant. While the presence of one or more dispersant may in some embodiments be useful for stabilisation of the submicron particles formed, the inventor has found that at least in some embodiments the presence of one or more dispersant is not necessary. Without wishing to be bound by theory, the inventor believes that in such embodiments the submicron particles formed may be stabilised to aggregation and/or settling by other components present in the composition as described herein.

The aqueous alkaline solution may be provided by providing aqueous alkaline precursor solution comprising the metal, and the one or more ligands that forms a soluble complex with the metal under alkaline conditions and optionally admixing the one or more dispersant. In certain embodiments, two or more different dispersants may be admixed simultaneously or sequentially with the precursor solution.

The aqueous alkaline solution may further comprise one or more surfactant. The one or more surfactant may be admixed with the precursor solution prior to or during optionally admixing the dispersant or admixed with alkaline solution after optionally admixing the one or more dispersant.

The pH of the alkaline solution or precursor solution may be adjusted as necessary by admixing acid or base, for example prior to optionally admixing the dispersant or prior to admixing the source of carbon dioxide.

The alkaline solution and precursor solution may also comprise one or more organic solvent as described herein.

The alkaline solution comprising the soluble metal complex can have a pH of at least 9, for example at least 9.5, 10, 10.5, 11, 11.5, 12, 12.5, 13, 13.5, or 14, and useful ranges may be selected from any two of those values. The alkalinity can be contributed by an alkali hydroxide, ammonia or an amine.

The pH of the alkaline solution is reduced in the method such that submicron particles of the metal salt precipitate. The pH of the alkaline solution may be reduced to a pH from 4.5 to about 10, such as about 4.5 to about 9, for example from about 5 to 9, 5.5 to 9, 6 to 9, 6.5 to 9, or 7 to 9. In certain embodiments, the pH of the alkaline solution is reduced to a pH from about 6 to about 9. In other embodiments, the pH of the alkaline solution may be reduced to a pH from about 6 to about 10, for example about 7.5 to 9.5. In certain exemplary embodiments, the pH of the alkaline solution is reduced to a pH from about 8 to 9.

In certain embodiments, the method comprises precipitation of the submicron particles of a metal salt from the aqueous alkaline solution onto a substrate, for example, particles of carbon, silica or a clay, which may also be submicron particles.

The aqueous alkaline solution or precursor solution may be prepared by reacting a source of the metal and the one or more ligand that forms a soluble complex with the metal under alkaline conditions in an aqueous alkaline medium comprising a base. The reaction may be carried out at any suitable temperature, for example from 5 to 95, 10 to 90, or 20 to 50° C. Advantageously, in various embodiments the reaction may be carried out at ambient temperature.

The soluble complex formed may be a metal-glycol complex, metal-ammine complex, or metal-amine complex. Ligands that forms such soluble complexes include but are not limited to ammonia, amines, and glycols, such as diols, triols and polyhydric alcohols.

The base that provides the alkaline conditions under which the soluble complex is formed can be alkali metal hydroxide such as sodium hydroxide or potassium hydroxide, ammonia, or an amine. Where the ligand is ammonia or an amine, the ligand can also act as the base in the reaction.

The source of the metal reacted with the one or more ligand can be a metal compound or elemental metal. The source of the metal is typically a solid that is dissolved on reaction with the one or more ligand under alkaline conditions. The metal compound may be a metal salt, for example copper carbonate, cupric hydroxide, cupric oxide, zinc carbonate, zinc hydroxide, or zinc oxide. In another example, the metal salt may be copper borate.

The elemental metal can be elemental copper, which for example dissolves on reaction with ammonia and carbonate with oxygen (or oxygen in air).

Those versed in the art know that various metals, for example metals of the first transition series, are capable of forming metal-ligand complexes.

The metal complex formed in the method of the present invention can be a metal-ammine or metal-amine complex. In a metal-ammine complex the metal is complexed with at least one ammonia (or ammine) ligands. For example, cuprammonium is a copper-ammine complex having the formula Cu(NH₃)₄²⁺. The 2+ charge of the complex is balanced by one or more suitable anions, such as a carbonate anion to give cuprammonium carbonate or borate to give cuprammonium borate. Cuprammonium carbonate is a cationic octahedral complex. Other examples of metal-ammine complexes include Co(NH₃)₄, Zn(NH₃)₆ and Ni(NH₃)₆.

Many of the first transition series of metals form tetra-ammine complexes. Metals of the second, third and fourth transition series can form similar compounds. Some form alternative complexes, for example silver, which forms a di-ammine complex. Copper and nickel can, for example, form hexa-ammine complexes.

Submicron particle dispersions of salts of these metals or oxides or hydroxides thereof, are useful in various applications as described herein. The method of this invention, in certain embodiments, provides an advantageous means of obtaining such dispersions.

In certain embodiments, the metal complex is a copper tetra-ammine complex; Cu(NH₃)₄²⁺. The stoichiometry of metal to ligand in such complexes can sometimes be critical to solubility. For example, Cu(NH₃)₄²⁺ has high solubility, whereas Cu(NH₃)₂²⁺ does not. Similarly, Ag(NH₃)₂²⁺ has high solubility, whereas Ag(NH₃)²⁺ does not.

In embodiments the method of the present invention, the stoichiometric ratio of ligand to metal is such that the complex formed is soluble in the aqueous alkaline solution. In some embodiments wherein the metal is copper, the copper:ammine stoichiometric ratio can be in the order of 1:4. In some embodiments, the ratio of metal to ammonia ligand is changed during formation of the submicron particles of the metal salt by reaction of the carbon dioxide provided by the source of carbon dioxide with the ligand. It will be appreciated that when the copper to ammonia ligand ratio is 1:4, this high level of ammonia can cause the pH to be high. Upon controlled addition of carbon dioxide, the pH is reduced and the ammine complex decomposes to form the sub-micron particles.

In a metal-amine complex the metal is complexed with at least one amine. Examples of suitable amines include, but are not limited to, monoethanolamine, diethanolamine, triethanolamine, ethylenediamine, and the like.

The stoichiometric ratio of metal to amine or ammonia may vary depending on the metal and the denticity of the amine. For example a bidentate ligand such as ethylene diamine may occupy two coordination sites for a metal. In various embodiments, the stoichiometric ratio of metal to ammonia or amine is at least from about 1:1 to 1:6. In certain exemplary embodiments, the stoichiometric ratio of metal to ammonia is at least 1:4.

In various embodiments, the alkaline solution and/or precursor solution comprises a metal ammine complex or metal amine complex, wherein the ammine or amine of the complex is provided by ammonia or an amine, and wherein the pH is at least 9, for example at least 9.5, 10, 10.5, 11, 11.5, 12, 12.5, 13, 13.5, or 14, and useful ranges may be selected from any two of these values.

The ammine or amine metal complex may be prepared by reacting a metal salt with ammonia or an amine to form an octahedral complex. In one embodiment, the metal compound and the ammine or amine are self-basifying, for example ammonia, to form the ammine or amine complex. Other methods of preparing the ammine or amine metal complex will be apparent to those skilled in the art.

The metal complex can be a metal-glycol complex, such complex being a complex of the metal and one or more glycol, for example a 1,2 diol such as glycerol or a 1,3 diol such as 1,3 propanediol. A metal-glycol complex may be referred to herein as a metal glycolate.

The preparation of alkaline solutions of metal-glycol complexes is described in PCT/IB2012/053836 (published as WO 2013/014644), the entirety of which is incorporated herein by reference.

In certain exemplary embodiments, the metal complex is a copper-glycol complex. In some embodiments, the copper-glycol complex (or copper glycolate) is an anionic species comprising copper complexed by one or more glycol at high pH to form a soluble copper complex having an overall 2− charge.

The glycol comprises at least two hydroxyl groups capable of reacting with a copper species to form a glyolate. Raising the pH using an alkaline compound forms the copper 2− complex. The 2− charge may be balanced by any suitable cation.

In one embodiment, the glycol is a di-, tri-, or polyhydric alcohol. In one embodiment, at least two of the hydroxyl groups are in a 1,2- (i.e. vicinal) or 1,3-relationship with respect to each other capable of forming the metal-glycol complex. Examples of suitable glycols include, but are not limited to ethylene glycol, propylene glycol, and glycerol.

In one embodiment, the glycol is a di-, tri-, or polyhydric alcohol, or a mixture thereof. In one embodiment, the di-, tri-, or polyhydric alcohol is a C₂-C₂₀alcohol. In one embodiment, the C₂-C₂₀alcohol is a C₂-C₆di-, tri-, or polyhydric alcohol, a polymeric alcohol, or a mixture thereof.

In one embodiment, the polymeric alcohol is a polyether polymer of one or more C₂-C₆di-, tri-, or polyhydric alcohols. In one embodiment, the glycol is a C₂-C₆di-, tri-, or polyhydric alcohol or a polyether polymer of one or more thereof,

In one embodiment, the C₂-C₆di-, tri-, or polyhydric alcohol is a lower alkylene or lower alkenylene glycol. In one embodiment, the C₂-C₆di-, tri-, or polyhydric alcohol is a lower alkylene glycol. In one embodiment, the C₂-C₆di-, tri-, or polyhydric alcohol is a lower alkylene diol or triol. In one embodiment, the glycol is selected from the group consisting of ethylene glycol, propylene glycol, glycerol, or a mixture thereof. In one embodiment, the glycol is selected from the group consisting of ethylene glycol, glycerol, or a mixture thereof.

In one embodiment, the glycol is a vicinal diol. In another embodiment, the glycol is a polyhydroxy compound. In one embodiment the glycol is a sugar or polyol.

Numerous glycols are commercially available.

In one embodiment, the glycol is selected from the group consisting of ethylene glycol, propylene glycol, glycerol, and mixtures thereof. In another embodiment, the glycol is ethylene glycol, glycerol, or a mixture thereof. In one embodiment, the glycol is ethylene glycol. In another embodiment, the glycol is glycerol.

In one embodiment, the metal-glycol complex is a compound of the formula (I):

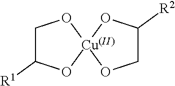

wherein the complex carries an overall double negative charge; and wherein R¹ and R² are each independently selected from the group consisting of hydrogen, hydroxymethyl, alkyl, alkoxy, substituted carboxy, and the like.

In one embodiment, R¹ and R² are each hydrogen and the compound is a copper (II) ethylene glycol complex (copper (II) attached to two ethylene glycol ligands).

In another embodiment, R¹ and R² are each hydroxymethyl and the compound is copper (II) glycerolate.

Those skilled in the art will appreciate that the compound of formula (I) can carry a charge when in solution (charge not shown), such as when in the presence of a strong alkali. The charge may be balanced by the presence of any suitable counter-ion(s) in the necessary stoichiometry. For example, when the compound of formula (I) has a charge of −2, the anionic charge may be balanced by the presence of one divalent cation or two mono-valent cations. In one embodiment, the counter-ions are sodium cations.

Those versed in the art of coordination chemistry will be aware that transition metals in the presence of suitable ligands can form coordination complexes. For example, copper is capable of forming octahedral coordination complexes typified by a deep blue colour, as observed in the Examples described herein.

An example of an octahedral copper glycol coordination complex is shown below. The copper glycol complex has four bonds between the copper atom and the oxygen atoms of the two glycol ligands, therefore two additional ligands can participate in formation of the octahedral complex. Suitable additional ligands include, for example, water (as shown below), ammonia (ammine), amines, alcohols, organic acids, bidentate ligands, for example ethylenediamine, or other suitable molecules. The copper complex carries an overall double negative charge (not shown in the structure below), hence the solubility in a medium of high pH and/or the formation of salts with alkali metals.

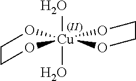

Without wishing to be bound by theory, the inventor believes that the copper glycol compound prepared in Example 1 below comprises Na₂CuC₆H₁₂O₆.2H₂O.

Those versed in the art will know that the complex of Example 2 is otherwise named as copper bisethane-1,2-diolato bisaquo copper (II) disodium salt. Similarly if glycerol is used as the glycol as in the other examples, the complex can be named 3-hydroxypropan-1, 2-diolato, bisaquo copper (II), disodium salt.

Whilst in this document the term glycolate may be used to describe such compounds, it will be apparent that such complexes are not metal salts of glycolic acid. In the metal-glycol complex, each of the one or more glycol comprises two or more hydroxyl groups, the oxygen atoms of which coordinate to the metal. The one or more glycol does not comprise a carboxylic acid.

A person skilled in the art will appreciate that the different metal species can accommodate different numbers of ligands. The oxidation state of the metal species can affect the number of ligands that species can accommodate.

The oxidation state of the metal species and the nature of the ligands, including the glycol ligand(s), determine the overall charge of the metal-glycol complex. The charge may be balanced by the presence of any suitable cation or, if applicable, anion in the necessary stoichiometry. Examples of cations include metal cations, for example alkali or alkaline earth metal cations, for example lithium, sodium, potassium, magnesium, and calcium cations. Examples of anions include inorganic anions, for example halogen anions, for example, fluorine, chlorine, bromine, and iodine anions, sulphate, phosphate, hydroxide, nitrate, carbonate, and bicarbonate anions, and organic anions, for example alkoxides, acetates, and carboxylates. Other cations and anions will be apparent to those skilled in the art.

The metal-glycol complex comprises at least one glycol. In one embodiment, the metal-glycol complex comprises two glycol ligands. In another embodiment, the glycolate comprises three glycol ligands.

The metal-glycol complex may further comprise one or more ligands that are not glycols. In one embodiment, the metal-glycol complex comprises one or more water ligands. In another embodiment, the metal-glycol complex comprises one or more alcohol ligands. In another embodiment, the metal-glycol complex comprises one or more ammonia or amine ligands. In one embodiment, the metal-glycol complex comprises one or more ligands selected from water, alcohol, ammonia, amine and mixtures thereof.

Sometimes it may be preferred to have a mixture of ligands. In one embodiment, such ligands might include glycols in admixture with ammonia, amines and/or water. In one embodiment, such ligands might include glycols in admixture with ammonia and/or amines. In another embodiment, such ligands might include glycols in admixture with water. Examples of suitable amines include, but are not limited to, monoethanolamine, diethanolamine, triethanolamine, ethylenediamine, and the like.

In some embodiments, the stoichiometric ratio of the glycol to the metal (for example, copper) is from about 1:1 to about 3:1, from about 1:1 to 2:1, or about 2:1.

In various embodiments, the metal-glycol complex is formed by reaction of a glycol with a metal species under alkaline conditions wherein the glycol is one or more of ethylene glycol, propylene glycol or glycerol. In another embodiment, other glycols are used.

In certain embodiments, the alkaline solution and/or precursor solution comprises a copper glycerolate in an aqueous liquid medium, wherein the pH of the composition is at least about 11, for example 11.5, 12, 12.5, 13, 13.5, or 14, and useful ranges may be selected between any two of those values.

The term “aqueous” as used herein with reference to a composition, solution, dispersion, colloid, or other liquid means that the composition, solution, dispersion, colloid, or other liquid comprises at least 10% water by weight of the composition, solution, dispersion, colloid, or liquid, preferably at least 15, 20, 25, or 30% water by weight.

The aqueous alkaline solution and/or aqueous precursor solution and/or aqueous composition comprising submicron particles can therefore comprise water in an amount from about 10 to 99.5% by weight of the composition, for example from about 10 to 99.5, 15 to 99.5, 20 to 99.5, 25 to 99.5, 30 to 99.5, 35 to 99.5, 40 to 99.5, 45 to 99.5, 50 to 99.5, 60 to 99.5, 70 to 99.5, 80 to 99.5, or 90 to 99.5% by weight of the composition.

The alkaline solution and/or precursor solution and/or the aqueous composition comprising the submicron particles may further comprise one or more organic solvent. The one or more organic solvent may be an alcohol, a ketone, a lactam, glycol ether, or a combination of any two or more thereof. In one embodiment, the alcohol is a C₁-C₆alcohol. In one embodiment, the alcohol is selected from methanol, ethanol, n-propanol, i-propanol, n-butanol, sec-butanol, iso-butanol, tert-butanol, and mixtures thereof. In one embodiment, the alcohol is selected from methanol, ethanol, n-propanol, i-propanol and mixtures thereof. In one embodiment, the alcohol is selected from the group consisting of methanol, ethanol, and mixtures thereof. In one embodiment, the alcohol is methanol. In another embodiment, the alcohol is ethanol.

In various embodiments, the aqueous alkaline solution and/or aqueous precursor solution and/or the aqueous composition comprising the submicron particles formed therefrom comprises water and one or more simple alcohol (for example C1-6alcohols) or mixtures thereof.

The alkaline solution or precursor solution may further comprise a glycol or a mixture of glycols (for example, where the soluble metal complex is a metal-glycol complex).

The metal-glycol complex may be prepared by reacting a metal salt with a glycol to form the metal-glycol complex. In one embodiment, the metal species and the glycol are reacted in the presence of a base, for example sodium or potassium hydroxide, to form the complex. Other methods of preparing metal-glycol complexes will be apparent to those skilled in the art.

In various embodiments, the method produces free glycol and the glycol is recovered for reuse.

In various embodiments, the method produces ammonium carbonate and the ammonium carbonate is recovered for reuse.

In another aspect, the present invention relates to a composition comprising submicron particles of a metal salt prepared by a method of the present invention.

In another aspect, the present invention relates to a method of treating a substrate, the method comprising applying to the substrate a composition comprising submicron particles of a metal salt prepared by a method according to the present invention.

The composition comprising submicron particles may be an aqueous composition comprising submicron particles as described herein. Advantageously, the aqueous composition may be in the form of a colloidal dispersion suitable for treating lignocellulosic substrate such as lumber.

In another aspect, the present invention relates to a substrate treated according to a method of the present invention.

The substrate can be an organic substrate. In one embodiment, the organic substrate is lignocellulosic. In one embodiment, the lignocellulosic substrate is lumber or lumber composite. In one embodiment, the organic substrate is lumber.

In one embodiment the lumber is sufficiently dry to allow impregnation by the composition. In one embodiment, the substrate is lumber that is at or below fibre saturation.

The compositions of the invention may in certain embodiments offer considerable scope in providing biocides to the substrate and mitigate the health issues of using volatile ammonia or the cost of using amines.

The compositions of the invention may be used to impart various properties to the substrate, including biocidal protection or pigmentation. Persons of ordinary skill in the art to which the invention relates will no doubt appreciate various compositions that may be applicable to the invention.

By way of example, where treatment or prevention of infection or pre-infection by pest organisms is desired, compositions (biocide compositions) having pesticidal (fungicidal, bactericidal, insecticidal, for example) or preservative properties may be used.

The compositions may include compounds of use in waterproofing a substrate or providing fire retarding properties. A combination of treatment compounds (e.g. biocide and fire retardant) would clearly provide beneficial properties to the substrate. The compositions may include an inorganic pigment dispersion to alter the colour of the substrate.

Whilst not wishing to be constrained, biocides could include; copper, zinc, cobalt, boron, quaternary ammonium compounds, organo-iodine compounds, triazoles, boron compounds, insecticides such as synthetic pyrethroids and the like, or mixtures of these.

Fire retardants could include phosphorous compounds, guanidine compounds, melamine compounds, boron compounds or mixtures of these. In certain circumstances a biocide and/or fire retardant might be used where the composition comprises an added emulsifier or surfactant to prepare an emulsion in a solvent combination.

As used herein, “substrate” should be taken to mean any material which may be in need of delivery of a composition of the present invention; for example, for the purposes of treatment to protect the substrate from or remove or prevent or ameliorate growth of pest organisms on or within the substrate. Such substrate may be lignocellulosic, for example living trees, wood products, lumber or logs. The invention may be applicable to substrates containing a level of moisture, or those which are substantially dry, at or below fibre saturation. The invention may be applicable to substrates which are inorganic such as concrete or metals.

While the description focuses particularly on the delivery of compositions to lumber, plants, leather, paint and the like, it should be appreciated that the method may be applicable to other substrates.

At least in the case of lignocellulosic substrates, those which are “substantially dry” include lumber dried by traditional methods. Such lumber may contain moisture of approximately 1 to approximately 30 percent as a weight proportion of the lumber dry weight although in some instances the moisture content may be higher. Substantially dry lignocellulosic substrates include lumber which has been processed via kiln drying, RF vacuum drying and the like and may have been milled to a final, or near final product, and may include for example a lumber composite material.

“Pests” or “pest organisms”, as referred to herein, may include any organisms which may infect an organic substrate, such as wood. While the invention is particularly applicable to fungi, pest organisms may also include insects and the like. The fungi and pests will be well known to people skilled in the art.

When used herein, the term “treatment” in the context of treating a substrate should be taken in its broadest possible context. It should not be taken to imply that a substrate is treated such that pest organisms are totally removed, although in some embodiments this is preferable. Prevention, for example, prophylactic treatment, and amelioration of growth of pest organisms is also encompassed by the term “treatment”. Related terms such as “treating” and the like should be interpreted in the same manner.

The composition of submicron particles may be applied to a surface of the substrate or to the interior of the substrate using any known means of bringing a composition into contact with a material. By way of example, the composition is applied by dipping, deluging, spraying, or brushing.

While the inventor does not believe it necessary to apply active pressure to effect delivery of a composition in accordance with the invention, there may be instances where active pressure systems (positive pressure or vacuum) may be used to assist with delivery. Reference is made to the delivery system described in WO 2004/054765 in this regard by way of example, the entirety of which is hereby incorporated by reference.

While the operating temperature suitable for application of the composition may vary depending on the nature of the submicron particles, biocides (or co-biocides) if present, and other components of the composition, for example its solubility and the like, the composition may be applied at or around ambient temperature. Temperatures of up to 100° C. could be used depending on the components of the composition. Higher temperatures, however, add to energy costs.

As mentioned hereinbefore, the method of the present invention is applicable to substrates which are substantially dry (i.e. at or below fibre saturation). In one embodiment, the composition is applied to the substrate which is at or below fibre saturation.

The quantity of composition used and/or the content of the submicron particles in the composition may be selected to provide the desired level of treatment.

In some embodiments, the composition of the invention is used to impregnate or infuse the organic substrate with the metal salt.

In many countries there are treatment standards for timber (for example, NZ3640) that set out the requirements for penetration of preservatives into the wood and retention of a given level of preservative for each hazard class. The higher the level of risk or hazard class the greater the level of retention required. For ACQ-type preservatives, copper retention is typically about 0.22% m/m, 0.7% m/m, and 0.9% m/m for H3.2, H4, and H5 timber, respectively. Advantageously, in some embodiments, the composition of the present invention is used to provide timber with comparable retention of biocide.

In other embodiments, the composition of the invention is applied to the surface of the organic substrate as a prophylactic treatment.

The method may optionally comprise a pH adjustment step to increase or decrease the pH of the composition comprising the submicron particles of the metal salt prior to application of the composition to the organic substrate, as described hereinbefore.

The compositions of the invention might conveniently be applied to living plants by a wide variation of processes, for example by dipping, spraying or by soil application.

The inventor has found that the process of the present invention can be used to prepare aqueous submicron particle biocide compositions which are stable to settling and/or agglomeration and which readily disperse in water. Current biocide technology cannot provide such simple small particle species without use of expensive equipment, considerable energy or use of expensive solvents. The method of the present invention can be carried out using simple processing techniques without excessive capital expenditure and without high energy costs typically involved with wet milling techniques. The method may also reduce the need for high levels of solvents, surfactants, etc. which otherwise add cost without adding biological performance.

### EXAMPLES

The following non-limiting examples are provided to illustrate the present invention and in no way limit the scope thereof.

### Example 1

1.1 g (0.005 mol) Basic copper carbonate equivalent to 0.01 mol copper was added to a reaction vessel. To this was added 1.9 g (0.02 mol) glycerol plus 20 ml water giving a pale green opaque suspension. With agitation 0.4 g (0.01 mol) sodium hydroxide was slowly added until all the basic copper carbonate was dissolved resulting in a deep blue solution. The copper species was present as a copper glycerolate (i.e. a copper-glycerol complex).

To this was added 0.3 g of a polyacrylate dispersant in water. The dispersant was Orotan 731 DP. The mixture was agitated to produce a transparent solution.

To the transparent solution was added an aqueous solution of carbon dioxide with strong agitation. As the pH was reduced insoluble basic copper carbonate precipitated from solution, providing a transparent greenish solution in the form of a submicron particle dispersion. The dispersion remained stable with no settling or agglomeration being observed for at least one month.

To confirm a submicron particle dispersion was formed, a quantity was placed in a clear colourless vessel. On viewing through the vessel the dispersion was completely transparent to the eye (as shown in FIG. 1). However, when a narrow beam of light from a LED based light source was shone through the fluid the region through which the beam passed appeared cloudy (as shown in FIG. 2). This observation of the Tyndall effect confirmed that a colloid or submicron particle dispersion had been created.

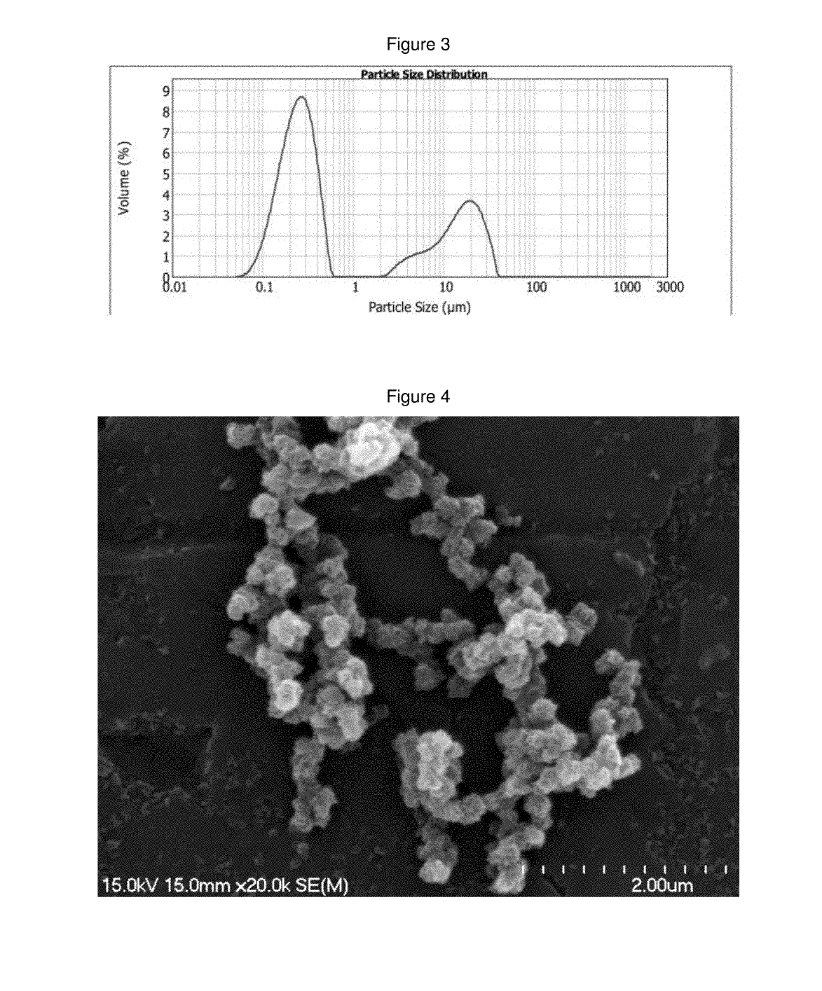

A sample of the composition was tested for particle size distribution using a Mastersizer 2000 Ver. 5.60 from Malvern Instruments Ltd, Malvern, UK. The particle size distribution is shown in FIG. 3. It is clear that the particles in the range of 100 nm to 400 nm have been prepared. The distribution of particles shown from 2 to 30 um is believed to be an artefact of the test method.

### Example 2

A colloidal dispersion of basic copper carbonate was prepared by following a procedure identical to that described in Example 1, except that the glycerol was replaced with a stoichiometric equivalent amount of ethylene glycol (to form a copper-ethylene glycol complex or copper ethylene glycolate, rather than a copper glycerolate or copper-glycerol complex).

### Example 3

A solution of copper glycerolate was prepared by following the procedure described in Example 1. To this was added 0.3 g of a polyacrylate dispersant in water. The dispersant was Orotan 731 DP. The mixture was agitated to produce a transparent solution.

Through the transparent solution was bubbled carbon dioxide gas until the pH declined to below 10. This resulted in a transparent submicron particle dispersion of basic copper carbonate. As in Example 1 using a light beam (to observe the Tyndall effect) demonstrated a colloidal dispersion was present.

### Example 4

A solution of copper glycerolate was prepared by following the procedure described in Example 1. To this was added 0.3 g of a polyacrylate dispersant in water. The dispersant was Orotan 731 DP. The mixture was agitated to produce a transparent solution.

Through the transparent solution was bubbled carbon dioxide gas until the pH declined to 9. This resulted in a transparent submicron particle dispersion of basic copper carbonate. As in example 1 using a light beam demonstrated a colloidal dispersion was present.

### Example 5

A solution of copper glycerolate was prepared by following the procedure described in Example 1. To this was added 0.1 g polyacrylate dispersant in water. The dispersant was Orotan 731 DP. The mixture was agitated to produce a transparent fluid.

Through the transparent solution was bubbled carbon dioxide gas until the pH declined to 10. This resulted in a transparent submicron particle dispersion of basic copper carbonate. As in Example 1 using a light beam demonstrated a colloidal dispersion was present.

### Example 6

1.1 g (0.005 mol) Basic copper carbonate equivalent to 0.01 mol copper was added to a reaction vessel. To this was added 1.9 g (0.02 mol) glycerol plus 2 ml water giving a pale green opaque suspension. To this was added 0.3 g Orotan 731 DP was added. With agitation 0.4 g (0.01 mol) sodium hydroxide was slowly added until all the basic copper carbonate was dissolved resulting in a deep blue solution. The copper species was present as a copper glycerolate.

To this solution was added 140 ml of water at 10° C. saturated with carbon dioxide. This resulted in a colloidal dispersion of basic copper carbonate. The pH was 10.

### Example 7

A solution of cuprammonium carbonate was prepared by adding 1.1 g (0.005 mol) basic copper carbonate equivalent to 0.01 mol copper to a reaction vessel. 0.4 g (0.005 mol) Ammonium carbonate was added together with 20 ml water. 0.3 g Orotan 731 DP was stirred into the solution. With agitation ammonia solution (S.G. 0.880) was slowly added until the basic copper carbonate was completely dissolved to give an intense deep blue solution.

With vigorous agitation water at 10° C. saturated with carbon dioxide was added until the pH was 7. This resulted in a transparent light blue submicron particle dispersion of basic copper carbonate.

The inclusion of ammonium carbonate can improve dissolution of the copper carbonate but is not essential.

A scanning electron micrograph of the particles of the dispersion is shown in FIG. 4. The 2 um scale at the bottom right hand corner is divided into ten 200 nm increments. It can be seen that the particles are about 200 nm in size.

### Example 8

A sample of the basic copper carbonate dispersion prepared in Example 5, was heated to 80° C. for a period of 10 minutes. The dispersion darkened to a black brown colour. This was a dispersion of cupric oxide.

### Example 9

A sample of the dispersion of basic copper carbonate prepared in Example 7 was tested in a corrosion study. Two mild steel metal coupons were placed in a volume of the dispersion. After 7 days there was no evidence of corrosion on the steel coupons.

Typically, corrosion occurs by displacement of copper from solution onto the coupons, this is recognised by either copper plating or formation of various oxides of copper and/or iron on the metal surface. The steel coupons remained bright and shiny indicating no displacement.

A further study comparing generic ACQ with a composition of this invention was carried out. Solutions of equal copper concentration were prepared and steel coupons added and monitored visually. Within 4 days the coupons exposed to ACQ exhibited rusting and formation of black deposits and appearance changed completely. Coupons exposed to the composition of this invention remained bright and shiny after 5 weeks.

### Example 10

A solution of cuprammonium carbonate was prepared following the procedure described in Example 7, except that 0.15 g Orotan 731 DP was added together with 0.15 g Corolan OT (a naphthalene sulphonic acid formaldehyde condensate) instead of 0.3 g Orotan 731 DP.

The sample was flushed with vigorous agitation with carbon dioxide gas. This resulted in a transparent submicron particle dispersion of basic copper carbonate.

### Example 11

A solution of cuprammonium carbonate was prepared following the procedure described in Example 7, except that 0.15 g Orotan 731 DP was added together with 0.15 g Corolan OT (a naphthalene sulphonic acid formaldehyde condensate) instead of 0.3 g Orotan 731 DP.

Prior to the addition of carbon dioxide, 0.1 g of sodium dodecylbenzenesulphonate, which is a surfactant dispersant, was added.

The sample was then flushed with vigorous agitation with carbon dioxide gas. This resulted in a transparent submicron particle dispersion of basic copper carbonate.

### Example 12

A colloidal dispersion of zinc carbonate was prepared. 0.01 mol zinc oxide was added to 20 ml water. To this was added 0.01 mol ammonium bicarbonate (0.79 g) plus 0.05 mol ammonia (0.85 g) as a 30% aqueous solution plus 0.3 g Orotan 731 DP to produce a clear colourless solution.

Water saturated with carbon dioxide was added with vigorous agitation until the pH was around 7. This resulted in a colourless fluid completely transparent to the eye. Upon illumination with a narrow beam of light it was possible to see the colloidal dispersion of zinc carbonate in the light beam as observed in earlier Examples.

### Example 13

A sample of ACQ (Ammoniacal Copper Quat) wood preservative was prepared according to the specifications of the American Wood Preservers Association. The sample was of the type comprising copper carbonate, ammonia and Carboquat. This comprised 1.1 g basic copper carbonate equivalent to 0.83 g cupric oxide (0.01 mol), plus 0.41 g didecyldimethylammonium carbonate as Carboquat. To this was added 0.005 mol ammonium bicarbonate (0.4 g) plus 2.28 g ammonia as a 30% aqueous solution. The sample was a deep blue transparent aqueous fluid.

An aliquot was taken equivalent to 1.1 g basic copper carbonate. To this was added 0.4 g Atlox 4894 (an ethylene oxide/propylene oxide copolymer non-ionic dispersant). As a non-ionic dispersant, Atlox 4894 is compatible with Carboquat, which is a cationic surfactant. The use of an anionic surfactant or dispersant, for example sodium dodecylbenzenesulphonate, was avoided as this could cause precipitation by reaction with the cationic surfactant.

With vigorous agitation water saturated with carbon dioxide was added. This resulted in a pale light blue dispersion of copper carbonate with didecyldimethylammonium carbonate remaining in solution.

### Example 14

A sample of ACQ was prepared by first bare copper wire in an ammonia/ammonium bicarbonate aqueous solution using air as the oxidant until the copper was completely dissolved. To an aliquot of the solution was added Didecyldimethylammonium carbonate to provide a solution of ACQ as described in Example 13.

To this was added 0.4 g Atlox 4894. Water saturated with carbon dioxide was then added with vigorous agitation. This resulted in a pale light blue optically transparent dispersion of copper carbonate.

### Example 15

A colloidal dispersion of basic copper carbonate was prepared by following the procedure described in Example 7 above, except that the Orotan was replaced with 0.3 g Polyvinylpyrrolidone (K15). This produced a flocculant composition, which upon dilution in water provided a stable submicron particle dispersion.

### Example 16

A colloidal dispersion of basic copper carbonate was prepared by following the procedure described in Example 7 above, except that the Orotan was replaced with 0.3 g Polyvinylpyrrolidone (K15). To the resultant composition was added 0.1 g sodium dodecylbenzenesulphonate in water. This produced a stable submicron particle dispersion. The dispersion was stable upon further dilution in water.

### Example 17

A solution of cuprammonium carbonate was prepared by adding 1.1 g (0.005 mol) basic copper carbonate equivalent to 0.01 mol copper to a reaction vessel. 0.4 g (0.005 mol) Ammonium carbonate was added together with 20 ml water. 0.3 g Orotan 731 DP was stirred into the solution. With agitation ammonia solution (S.G. 0.880) was slowly added until the basic copper carbonate was completely dissolved to give an intense deep blue solution. 0.6 g Borax (sodium tetraborate) pentahydrate was then added.

With vigorous agitation water at 10° C. saturated with carbon dioxide was added until the pH decreased to 9. The fluid remained a clear blue solution by sight (i.e. a clear blue fluid transparent to the naked eye). The fluid was a stable colloidal dispersion of submicron particles of a copper salt.

The inventor believes the fluid may comprise submicron particles of basic copper borate.

### Example 18

A colloidal dispersion of basic copper carbonate was prepared following the procedure described in Example 7 above, except that the 0.3 g Orotan was replaced with 0.4 g Atlox 4894.

To the blue solution was added carefully a stoichiometric amount of alkali to convert the copper carbonate produced to copper hydroxide, by abstraction of the carbonate anion. This was evidenced by a colour change from mid blue to light blue.

The sample was then heated to 80° C. for 4 minutes, whereby the copper hydroxide was converted to black copper oxide.

### Example 19

A solution of cuprammonium carbonate was prepared following the procedure described in Example 7.

With agitation water at 10° C. saturated with carbon dioxide was added until the pH was 8. This resulted in a transparent light blue submicron particle dispersion of basic copper carbonate.

### Example 20

To a sample of the basic copper carbonate dispersion prepared in Example 19 above was added 0.2 g of sodium tetraborate tetrahydrate. After agitation to ensure full dissolution, the pH was measured to be 9. No precipitation was observed; the dispersion remained transparent.

### Example 21

To a sample of the dispersion prepared in Example 13 above was added 0.2 g of sodium tetraborate pentahydrate. After agitation to ensure full dissolution, the pH was measured to be 9. No precipitation was observed.

### Example 22

A solution of cuprammonium borate was prepared by adding 1.5 g (0.005 mol) copper borate equivalent to 0.005 mol copper to a reaction vessel. 0.3 g Orotan 731 DP was stirred into the solution. With agitation ammonia solution (S.G. 0.880) was slowly added until the basic copper borate was completely dissolved to give an intense deep blue solution.

With agitation water at 10° C. saturated with carbon dioxide was added until the pH was 8. This resulted in a transparent light blue dispersion believed to be submicron particles of basic copper borate.

### Example 23

A sample of ACQ (Ammoniacal Copper Quat) wood preservative was prepared according to the specifications of the American Wood Preservers Association. The sample was of the type comprising copper carbonate, ammonia and Carboquat. This comprised 1.1 g basic copper carbonate equivalent to 0.83 g cupric oxide (0.01 mol), plus 0.41 g didecyldimethylammonium carbonate as Carboquat. To this was added 0.005 mol ammonium bicarbonate (0.4 g) plus 2.28 g ammonia as a 30% aqueous solution. The sample was a deep blue transparent aqueous fluid.

An aliquot was taken equivalent to 1.1 g basic copper carbonate.

With agitation water saturated with carbon dioxide was added. This resulted in a pale light blue transparent dispersion of copper carbonate with didecyldimethylammonium carbonate remaining in solution.

In contrast to the procedure described in Example 13, no Altox 4894 was added.

Without wishing to be bound by theory the inventor believes that the dispersion of submicron particles of the insoluble metal salt is stabilised to aggregation and/or settling by the ammonium carbonate formed when carbon dioxide is added to the ammine complex in solution. Two molecules of ammonium carbonate are generated upon addition of the carbon dioxide and decomposition of each soluble metal complex.

### Example 24

To a sample of the dispersion prepared in Example 19 was added some bright steel coupons to assess corrosivity. After one week there was no change in the appearance of the steel coupons or the liquid composition.

The foregoing Examples demonstrate that submicron particle dispersions of metal carbonates and/or borates can be prepared by simple inexpensive technology without the need for milling using costly plant and equipment and that corresponding metal hydroxides and metal oxides can also be prepared via this process.

### INDUSTRIAL APPLICATION

The compositions comprising submicron particles produced by the method of the present invention may be useful in various applications as will be apparent to those skilled in the art. For example, compositions comprising submicron particles of biocidal metal salts, can be used for treating substrates against biological degradation or biological pests. In particular, the compositions can be used to treat lignocellulosic substrates, such as lumber, plants including food crops, other biologically degradable substrates including leather, inorganic substrates such as concrete and non-biological substrates such as paint. The compositions may be used for the purpose of prevention of growth of pest organisms such as unwanted fungi, or for providing specific properties to the substrate, for example. The submicron particles can also comprise metal compounds which can be used as pigments and can also be used as, or converted to, catalysts.

The following paragraphs relate to aspects and embodiments of the invention:
1. A method of preparing a composition comprising submicron particles of a metal salt, the method comprising:
   providing an aqueous alkaline solution comprising a metal, one or more ligand that forms a soluble complex with the metal under alkaline conditions, and one or more dispersant; and
   admixing the solution and a source of carbon dioxide to reduce the pH of the solution such that submicron particles of a metal salt precipitate, thereby providing an aqueous composition comprising submicron particles of the metal salt.
2. The method of paragraph 1, wherein the aqueous composition is a colloidal dispersion; or the aqueous composition is a flocculated composition and the method further comprises deflocculating the composition to provide a colloidal dispersion.
3. The method of paragraph 1 or 2, wherein admixing the solution and the source of carbon dioxide reduces the pH of the solution such that submicron particles of a metal carbonate precipitate.
4. The method of any one of the preceding paragraphs, comprising admixing the solution, a source of carbon dioxide, and a source of one or more weak acid to reduce the pH of the solution such that submicron particles of a metal salt precipitate.
5. The method of paragraph 4, wherein the weak acid is a weak acid that has a pKa of at least about 6.
6. The method of paragraph 4 or 5, wherein the weak acid is a weak acid that forms a substantially insoluble salt with the metal in water at pH 7.
7. The method of any one of paragraphs 4-6, wherein the weak acid is boric acid or a phenol.
8. The method of paragraph 7, wherein the source of the weak acid is boric acid or a borate.
9. The method of any one of the preceding paragraphs, wherein the aqueous composition comprises submicron particles of a carbonate of the metal and the method further comprises treating the aqueous composition comprising submicron particles of a carbonate of the metal with a base to provide an aqueous composition comprising submicron particles of a hydroxide of the metal; and optionally heating the aqueous composition comprising submicron particles of a hydroxide of the metal to provide an aqueous composition comprising submicron particles of an oxide of the metal.
10. The method of any one of the preceding paragraphs, wherein the aqueous composition comprises submicron particles of a carbonate of the metal or a hydroxide of the metal and the method further comprises heating the aqueous composition comprising submicron particles of a carbonate of the metal to provide an aqueous composition comprising submicron particles of an oxide of the metal.
11. The method of any one of the preceding paragraphs, wherein the source of carbon dioxide is carbon dioxide gas, a solution comprising carbon dioxide, a latent source of carbon dioxide, or a combination of any two or more thereof.
12. The method of any one of the preceding paragraphs, wherein the source of carbon dioxide is carbon dioxide gas or a solution comprising carbon dioxide.
13. The method of any one of the preceding paragraphs, wherein the metal salt has a solubility in water of less than 0.1 g/L at 20° C.
14. The method of any one of the preceding paragraphs, wherein the pH of the solution is reduced to a pH from about 4.5 to about 9.
15. The method of any one of the preceding paragraphs, wherein providing the aqueous alkaline solution comprises:
   providing an aqueous alkaline precursor solution comprising a metal, and one or more ligand that forms a soluble complex with the metal under alkaline conditions; and
   admixing the one or more dispersant.
16. The method of any one of the preceding paragraphs, wherein providing the alkaline solution or alkaline precursor solution comprises reacting a source of the metal and one or more ligand that forms a soluble complex with the metal under alkaline conditions in an aqueous alkaline medium comprising a base.
17. The method of paragraph 16, wherein the base is an alkali metal hydroxide such as sodium hydroxide or potassium hydroxide, ammonia, or an amine.
18. The method of paragraph 16 or 17, wherein the source of the metal is a metal compound or elemental metal.
19. The method of any one of the preceding paragraphs, wherein the pH of the alkaline solution and/or alkaline precursor solution is at least 9.
20. The method of any one of the preceding paragraphs, wherein the one or more ligand is selected from the group consisting of ammonia, amines, and glycols, such as diols, triols, and polyhydric alcohols.
21. The method of any one of the preceding paragraphs, wherein the one or more ligand is selected from the group consisting of glycerol, ethylene glycol, and ammonia.
22. The method of any one of the preceding paragraphs, wherein the metal is a first, second, or third transition series metal.
23. The method of any one of the preceding paragraphs, wherein the metal is copper or zinc.
24. The method of any one of the preceding paragraphs, wherein the aqueous alkaline solution and/or aqueous alkaline precursor solution and/or aqueous composition comprises one or more organic solvent.
25. The method of any one of the preceding paragraphs, wherein the aqueous alkaline solution and/or aqueous alkaline precursor solution and/or aqueous composition comprising submicron particles further comprises one or more surfactant.
26. The method of any one of the preceding paragraphs, further comprising admixing one or more surfactant with the alkaline solution and/or alkaline precursor solution and/or the aqueous composition comprising submicron particles.
27. The method of any one of the preceding paragraphs, further comprising admixing one or more additional dispersant with the alkaline solution and/or the aqueous composition comprising submicron particles.
28. The method of any one of the preceding paragraphs, wherein the dispersant is an anionic dispersant such as a polycarboxylate for example polyacrylate, a naphthalene sulphonate formaldehyde condensate, a lignosulphonate, a melamine sulphonate formaldehyde condensate, an alkyl-aryl ether phosphate, or an alkyl ether phosphate, a cationic dispersant, a non-ionic dispersant such as a polyether including mixed polyethers, a zwitterionic dispersant such as a zwitterionic polymer, or a combination of any two or more thereof.
29. The method of any one paragraphs 25-28, wherein the surfactant is an anionic surfactant such as dodecylbenzenesulphonate, lauryl sulphate, or dodecylsulphate, a cationic surfactant such as benzalkonium chloride or hexadecyltrimethylammonium bromide, a non-ionic surfactant such as nonylphenolethoxylate or octylphenol ethoxylate, a zwitterionic surfactant, or a combination of any two or more thereof.
30. The method of any one of the preceding paragraphs, further comprising adjusting the pH of the alkaline solution and/or the alkaline precursor solution and/or the aqueous composition comprising submicron particles by admixing acid or base.
31. The method of any one of the preceding paragraphs, wherein the aqueous composition comprising submicron particles is a colloidal dispersion stable to agglomeration and/or settling for a period of at least 1, 2, 3, 4, 5, 6, or 7 days under standard conditions.
32. The method of any one of the preceding paragraphs, wherein the composition comprising submicron particles further comprises one or more biocide.
33. The method of paragraph 32, wherein the biocide is a fungicide, insecticide, moldicide, bactericide, or algicide.
34. The method of any one of the preceding paragraphs, further comprising admixing one or more biocide and the composition comprising submicron particles.
35. The method of any one of paragraphs 32-34, wherein the one or more biocide is in the form of a solution, an emulsion, a microencapsulation, or submicron particles.
36. The method of any one of the preceding paragraphs, wherein the composition comprising submicron particles comprises submicron particles of one or more biocide.
37. A composition comprising submicron particles of a metal salt prepared by a method according to any one of the preceding paragraphs.
38. A method of treating a substrate, the method comprising applying to the substrate a composition comprising submicron particles of a metal salt prepared by a method according to any one of the preceding paragraphs.
39. A substrate treated by a method according to paragraph 38.

Although the invention has been described by way of example and with reference to particular embodiments, it is to be understood that modifications and/or variations may be made without departing from the scope of the invention.

The entire disclosures of all applications, patents and publications, cited above and below, if any, are hereby incorporated by reference.

1. A method of preparing a composition comprising submicron particles of a metal salt, the method comprising:
providing an aqueous alkaline solution comprising a metal, one or more ligand that forms a soluble complex with the metal under alkaline conditions, and optionally one or more dispersant; and
admixing the solution and a source of carbon dioxide to reduce the pH of the solution such that submicron particles of a metal salt precipitate, thereby providing an aqueous composition comprising submicron particles of the metal salt.

2. The method of claim 1, wherein the method comprises:
providing an aqueous alkaline solution comprising a metal, one or more ligand that forms a soluble complex with the metal under alkaline conditions, and one or more dispersant.

3. The method of claim 1 or 2, wherein the aqueous composition is a colloidal dispersion; or the aqueous composition is a flocculated composition and the method further comprises deflocculating the composition to provide a colloidal dispersion.

4. The method of any one of claims 1 to 3, wherein admixing the solution and the source of carbon dioxide reduces the pH of the solution such that submicron particles of a metal carbonate precipitate.

5. The method of any one of claims 1 to 4, wherein admixing the solution and the source of carbon dioxide reduces the pH of the solution such that submicron particles of a metal borate precipitate.

6. The method of any one of the preceding claims, wherein the soluble metal complex is decomposed on reducing the pH of the alkaline solution.

7. The method of any one of the preceding claims, wherein the soluble metal complex reacts with carbon dioxide provided by the source of carbon dioxide.

8. The method of any one of the preceding claims, wherein one or more ligand of the soluble metal complex is released from the soluble metal complex and/or a salt of one or more ligand of the soluble metal complex is produced by decomposition of the soluble metal complex.

9. The method of any one of the preceding claims, wherein the one or more ligand or salt thereof reduces or prevents aggregation and/or settling of the submicron particles.

10. The method of any one of the preceding claims, wherein the one or more ligand or salt thereof is selected from ammonium carbonate, a carbonate of an amine, and a glycol.

11. The method of any one of the preceding claims, wherein the solution further comprises a source of one or more weak acid.

12. The method of any one of the preceding claims, comprising admixing the solution, a source of carbon dioxide, and a source of one or more weak acid to reduce the pH of the solution such that submicron particles of a metal salt precipitate.

13. The method of claim 12, wherein the weak acid is a weak acid that has a pKa of at least about 6.

14. The method of claim 12 or 13, wherein the weak acid is a weak acid that forms a substantially insoluble salt with the metal in water at pH 7.

15. The method of any one of claims 12-14, wherein the weak acid is boric acid or a phenol.

16. The method of claim 15, wherein the source of the weak acid is boric acid or a borate.

17. The method of any one of the preceding claims, wherein the aqueous composition comprises submicron particles of a carbonate of the metal and the method further comprises treating the aqueous composition comprising submicron particles of a carbonate of the metal with a base to provide an aqueous composition comprising submicron particles of a hydroxide of the metal; and optionally heating the aqueous composition comprising submicron particles of a hydroxide of the metal to provide an aqueous composition comprising submicron particles of an oxide of the metal.

18. The method of any one of the preceding claims, wherein the aqueous composition comprises submicron particles of a carbonate of the metal or a hydroxide of the metal and the method further comprises heating the aqueous composition comprising submicron particles of a carbonate of the metal to provide an aqueous composition comprising submicron particles of an oxide of the metal.

19. The method of any one of the preceding claims, wherein the source of carbon dioxide is carbon dioxide gas, a solution comprising carbon dioxide, a latent source of carbon dioxide, or a combination of any two or more thereof.

20. The method of any one of the preceding claims, wherein the source of carbon dioxide is carbon dioxide gas or a solution comprising carbon dioxide.

21. The method of any one of the preceding claims, wherein the metal salt has a solubility in water of less than 0.1 g/L at 20° C.

22. The method of any one of the preceding claims, wherein the pH of the solution is reduced to a pH from about 4.5 to about 9.

23. The method of any one of the preceding claims, wherein the pH of the solution is reduced to a pH from about 7.5 to 9.5.

24. The method of any one of the preceding claims, wherein the pH of the solution is reduced to a pH from about 8 to 9.

25. The method of any one of the preceding claims, wherein providing the aqueous alkaline solution comprises:
providing an aqueous alkaline precursor solution comprising a metal, and one or more ligand that forms a soluble complex with the metal under alkaline conditions; and
optionally admixing one or more dispersant.

26. The method of any one of the preceding claims, wherein providing the aqueous alkaline solution comprises:
providing an aqueous alkaline precursor solution comprising a metal, and one or more ligand that forms a soluble complex with the metal under alkaline conditions; and
admixing the one or more dispersant.

27. The method of any one of the preceding claims, wherein providing the alkaline solution or alkaline precursor solution comprises reacting a source of the metal and one or more ligand that forms a soluble complex with the metal under alkaline conditions in an aqueous alkaline medium comprising a base.

28. The method of claim 27, wherein the base is an alkali metal hydroxide such as sodium hydroxide or potassium hydroxide, ammonia, or an amine.

29. The method of claim 27 or 28, wherein the source of the metal is a metal compound or elemental metal.

30. The method of any one of the preceding claims, wherein the pH of the alkaline solution and/or alkaline precursor solution is at least 9.

31. The method of any one of the preceding claims, wherein the one or more ligand is selected from the group consisting of ammonia, amines, and glycols, such as diols, triols, and polyhydric alcohols.

32. The method of any one of the preceding claims, wherein the one or more ligand is selected from the group consisting of glycerol, ethylene glycol, and ammonia.

33. The method of any one of the preceding claims, wherein the metal is a first, second, or third transition series metal.

34. The method of any one of the preceding claims, wherein the metal is copper or zinc.

35. The method of any one of the preceding claims, wherein the aqueous alkaline solution and/or aqueous alkaline precursor solution and/or aqueous composition comprises one or more organic solvent.

36. The method of any one of the preceding claims, wherein the aqueous alkaline solution and/or aqueous alkaline precursor solution and/or aqueous composition comprising submicron particles further comprises one or more surfactant.

37. The method of any one of the preceding claims, further comprising admixing one or more surfactant with the alkaline solution and/or alkaline precursor solution and/or the aqueous composition comprising submicron particles.

38. The method of any one of the preceding claims, further comprising admixing one or more additional dispersant with the alkaline solution and/or the aqueous composition comprising submicron particles.

39. The method of any one of the preceding claims, wherein the dispersant is an anionic dispersant such as a polycarboxylate for example polyacrylate, a naphthalene sulphonate formaldehyde condensate, a lignosulphonate, a melamine sulphonate formaldehyde condensate, an alkyl-aryl ether phosphate, or an alkyl ether phosphate, a cationic dispersant, a non-ionic dispersant such as a polyether including mixed polyethers or polyvinylpyrrolidone, a zwitterionic dispersant such as a zwitterionic polymer, or a combination of any two or more thereof.

40. The method of any one claims 36-39, wherein the surfactant is an anionic surfactant such as dodecylbenzenesulphonate, lauryl sulphate, or dodecylsulphate, a cationic surfactant such as benzalkonium chloride or hexadecyltrimethylammonium bromide, a non-ionic surfactant such as nonylphenolethoxylate or octylphenol ethoxylate, a zwitterionic surfactant, or a combination of any two or more thereof.

41. The method of any one of the preceding claims, further comprising adjusting the pH of the alkaline solution and/or the alkaline precursor solution and/or the aqueous composition comprising submicron particles by admixing acid or base.

42. The method of claim 41, wherein the pH is adjusted by admixing boric acid and/or a borate, such as borax.

43. The method of any one of the preceding claims, wherein the pH of the aqueous composition comprising submicron particles is adjusted by admixing acid or base to a pH from about 7.5 to 9.5.

44. The method of any one of the preceding claims, wherein the pH of the aqueous composition comprising submicron particles is adjusted by admixing acid or base to a pH from about 8 to 9.

45. The method of any one of the preceding claims, wherein the aqueous composition comprising submicron particles is a colloidal dispersion stable to agglomeration and/or settling for a period of at least 1, 2, 3, 4, 5, 6, or 7 days under standard conditions.

46. The method of any one of the preceding claims, wherein the composition comprising submicron particles further comprises one or more biocide.

47. The method of claim 46, wherein the biocide is a fungicide, insecticide, moldicide, bactericide, or algicide.

48. The method of any one of the preceding claims, further comprising admixing one or more biocide and the composition comprising submicron particles.

49. The method of any one of claims 46-48, wherein the one or more biocide is in the form of a solution, an emulsion, a microencapsulation, or submicron particles.

50. The method of any one of the preceding claims, wherein the composition comprising submicron particles further comprises submicron particles of one or more biocide.

51. The method of any one of the preceding claims, wherein the composition, when tested using the AWPA E12 corrosion standard method, compared to standard ACQ, results in an mpy that is at least 20% less.

52. A composition comprising submicron particles of a metal salt prepared by a method according to any one of the preceding claims.

53. A method of treating a substrate, the method comprising applying to the substrate a composition comprising submicron particles of a metal salt prepared by a method according to any one of the preceding claims.

54. A substrate treated by a method according to claim 53.
